(19) United States
(12) Patent Application Publication
(10) Pub. No.: US 2024/0001834 A1
(43) Pub. Date: Jan. 4, 2024

(54) SYSTEM FOR TRUCK-MOUNTED/SELF-PROPELLED AERIAL WORK PLATFORM

(71) Applicant: All Access Equipment, Inc., Wilmington, MA (US)

(72) Inventor: Lenny Polonski, Wilmington, MA (US)

(73) Assignee: All Access Equipment, Inc., Wilmington, MA (US)

(21) Appl. No.: 18/342,405

(22) Filed: Jun. 27, 2023

Related U.S. Application Data
(60) Provisional application No. 63/424,094, filed on Nov. 9, 2022.
(60) Provisional application No. 63/357,126, filed on Jun. 30, 2022.

(51) Int. Cl. B60P 3/06; B62D 33/02; B60P 7/08; B66F 11/04

(52) U.S. Cl. CPC B60P 3/062; B62D 33/02; B60P 7/08; B66F 11/046

(57) ABSTRACT

A system, and associated methods, for use as a log truck are provided herein. The system may be installed onto a chassis of a vehicle, such as a standard truck, and used to transport one or more logs. The system may also be transitioned for use with an aerial lift. The aerial lift may be a self-propelled spider-type lift which is capable of automated self-unloading and loading onto the truck when used with the system described herein. The system may comprise a deck for supporting the aerial lift or one or more logs and a frame configured to be coupled beneath the deck and mounted onto the chassis of the truck.

### CROSS-REFERENCE TO RELATED APPLICATIONS

This application claims the benefit under 35 U.S.C. § 119(e) of U.S. Provisional Application Ser. No. 63/357,126, titled “SYSTEM FOR TRUCK-MOUNTED/SELF-PROPELLED AERIAL WORK PLATFORM” and filed on Jun. 30, 2022 under Attorney Docket No. A1335.70000US00, and U.S. Provisional Application Ser. No. 63/424,094, titled “SYSTEM FOR TRUCK-MOUNTED/SELF PROPELLED AERIAL WORK PLATFORM” and filed on Nov. 9, 2022 under Attorney Docket No. A1335.70001US00, each of which is hereby incorporated by reference in its entirety.

### BACKGROUND

Aerial work platforms, also referred to as aerial lifts, are a type of heavy equipment used to elevate an operator to provide access to areas that are difficult to reach without the use of an aerial lift. Aerial lifts may be used in various contexts, including in construction and building renovation, electrical work, and/or tree cutting, for example. Boom lifts are a common type of aerial lift which can move in multiple directions and reach heights of up to and above 100 feet.

### SUMMARY

According to some embodiments, there is provided a system comprising: a self-propelled aerial lift having a plurality of outriggers configured to support the aerial lift relative to a surface; a kit configured to be installed on a chassis of a truck, the kit comprising: a deck for supporting the self-propelled aerial lift; and a frame configured to be coupled beneath the deck and mounted onto the chassis of the truck, wherein the system is configured to be removably coupled to the aerial lift, and wherein a width of the frame and a width of the deck are each less than a width between rear tires of the chassis such that the deck and the frame are disposed between the rear tires of the chassis when the kit is installed on the chassis of the truck.

According to some embodiments, there is provided method for use with a self-propelled aerial lift, the method comprising: moving one or more outriggers of the self-propelled aerial lift from a folded configuration to a deployed configuration while the self-propelled aerial lift is supported by a deck of a system mounted on a chassis of a truck, wherein a distal end of each of the one or more outriggers at least partially supports the self-propelled aerial lift relative to a surface when the one or more outriggers are in the deployed configuration; operating the self-propelled aerial lift while the self-propelled aerial lift is supported by the deck of the system and the one or more outriggers are in the deployed configuration, wherein operating the self-propelled aerial lift comprises elevating a compartment of the self-propelled aerial lift configured to accommodate an operator; and unloading the self-propelled aerial lift from the deck of the system by remotely elevating the self-propelled aerial lift from the deck of the system such that the self-propelled aerial lift supports itself over the deck of the system and the deck can be removed from under the self-propelled aerial lift.

According to some embodiments, there is provided a method for use with a self-propelled aerial lift, the method comprising: loading the self-propelled aerial lift onto a deck of a system coupled to a chassis of a truck, by: remotely elevating the self-propelled aerial lift such that the chassis of the truck can be positioned beneath the self-propelled aerial lift; and lowering the self-propelled aerial lift onto the deck of the system such that the self-propelled aerial lift is supported by the deck of the system; and operating the self-propelled aerial lift while the self-propelled aerial lift is supported by the deck of the system and one or more outriggers are in a deployed configuration where a distal end of each of the one or more outriggers at least partially supports the self-propelled aerial lift relative to a surface, wherein operating the self-propelled aerial lift comprises elevating a compartment of the self-propelled aerial lift configured to accommodate an operator.

### BRIEF DESCRIPTION OF THE DRAWINGS

FIG. 1 illustrates an example system for use with a truck-mounted/self-propelled aerial lift, in accordance with some embodiments of the technology described herein.

FIG. 2 illustrates the example system of FIG. 1 with the first and second portions of the deck of the system separated, in accordance with some embodiments of the technology described herein.

FIG. 3 illustrates an exploded view of the example system of FIG. 1, in accordance with some embodiments of the technology described herein.

FIG. 4 illustrates the example system of FIG. 1 being installed on a truck chassis, in accordance with some embodiments of the technology described herein.

FIG. 5 illustrates a perspective view of the example system of FIG. 1 being installed on a truck chassis with a self-propelled lift loaded thereon, in accordance with some embodiments of the technology described herein.

FIG. 6 illustrates a top view of the example system of FIG. 1 being installed on a truck chassis with a self-propelled lift loaded thereon, in accordance with some embodiments of the technology described herein.

FIG. 7 illustrates a side view of the example system of FIG. 1 being installed on a truck chassis with a self-propelled lift loaded thereon, in accordance with some embodiments of the technology described herein.

FIG. 8 illustrates an example of a self-propelled lift loaded onto the example system of FIG. 1 and in a process of being deployed, in accordance with some embodiments of the technology described herein.

FIG. 9 illustrates another example of a self-propelled lift loaded onto the example system of FIG. 1 and in a process of being deployed, in accordance with some embodiments of the technology described herein.

FIG. 10 illustrates an example of a self-propelled lift loaded onto the example system and operating in a deployed position as a truck-mounted lift, in accordance with some embodiments of the technology described herein.

FIG. 11 illustrates an example of a self-propelled lift operating in a deployed position as a self-propelled lift, in accordance with some embodiments of the technology described herein.

FIG. 12 illustrates an example method for deploying an aerial lift from a system, in accordance with some embodiments of the technology described herein.

FIG. 13 illustrates an example method for deploying an aerial lift from a system, in accordance with some embodiments of the technology described herein.

FIG. 14 illustrates an example method for packing an aerial lift for transport via a system, in accordance with some embodiments of the technology described herein.

FIG. 15 illustrates aspects of a system for use as a log truck, in accordance with some embodiments of the technology described herein.

FIG. 16 illustrates an additional view of the system of FIG. 15, in accordance with some embodiments of the technology described herein.

FIG. 17 illustrates aspects of the system for use as a log truck, in accordance with some embodiments of the technology described herein.

FIG. 18 illustrates a rear view of the system of FIG. 15, in accordance with some embodiments of the technology described herein.

FIGS. 19-22 illustrates aspects of a frame of the system for use as a log truck, in accordance with some embodiments of the technology described herein.

FIGS. 23-29 illustrate aspects of a movable grapple of the system for use as a log truck, in accordance with some embodiments of the technology described herein.

FIG. 30 illustrates a stabilizer of the system for use as a log truck, in accordance with some embodiments of the technology described herein.

FIGS. 31A-31E illustrate use of a system to load a log onto a vehicle, in accordance with some embodiments of the technology described herein.

FIG. 32 illustrates an example method for loading one or more logs onto a system mounted on a chassis of a truck, in accordance with some embodiments of the technology described herein.

FIG. 33 illustrates an example method for converting a system for supporting an aerial lift into a system for transporting one or more logs, in accordance with some embodiments of the technology described herein.

FIG. 34 illustrates a perspective view of a system for use as a log truck mounted on a truck, in accordance with some embodiments of the technology described herein.

FIG. 35 illustrates a top view of the system of FIG. 34 mounted on a truck, in accordance with some embodiments of the technology described herein.

FIG. 36 illustrates a side view of the system of FIG. 34 mounted on a truck, in accordance with some embodiments of the technology described herein.

FIG. 37 illustrates a top view of a system for use as a log truck, in accordance with some embodiments of the technology described herein.

FIG. 38 illustrates a side view of the system of FIG. 37, in accordance with some embodiments of the technology described herein.

FIG. 39 illustrates a perspective view of the system of FIG. 37, in accordance with some embodiments of the technology described herein.

### DETAILED DESCRIPTION

Aspects of the technology described herein relate to a system for use with an aerial lift. For example, the system may be installed onto a vehicle, such as a standard truck, and used to transport an aerial lift. The aerial lift may be a self-propelled spider-type lift which is capable of automated self-unloading and loading onto the truck when used with the deck kit described herein. The system enables the aerial lift to easily transition between operating as a truck-mounted lift or as a self-propelled aerial lift, depending on the needs of the operator.

Previously, all aerial work platforms were strictly truck-mounted, meaning the aerial lift of the platform was permanently attached to a vehicle and could not be operated if separated from the vehicle. Such truck-mounted aerial work platforms have limitations. For example, truck-mounted aerial work platforms cannot be deployed in locations with unlevel terrain or with limited space (e.g., indoors or in a backyard).

More recently, self-propelled aerial lifts were introduced. Self-propelled aerial lifts have the benefit of reaching areas where it would be impossible to transport a truck-mounted lift. However, self-propelled lifts typically must be transported between sites with large platform vehicles. Accordingly, vehicles which transport these self-propelled lifts may require a commercial driver's license (CDL) to operate. CDL's have become difficult to obtain as they typically require expensive fees and lengthy study courses to acquire. In addition, the process of loading and unloading self-propelled lifts from the vehicle or ramp on which the self-propelled lift is transported may be time-consuming, dangerous, and/or require the assistance of multiple operators.

To achieve the benefits of both lifts while overcoming their disadvantages, users would need to purchase both types of lifts which is expensive and requires large amounts of space to store both types of lifts. The inventors have developed a system that enables a user to obtain the advantages of both a truck-mounted lift and a self-propelled lift within one unit. According to some aspects, there is provided a system for enabling an aerial lift to easily transition between operation as a self-propelled lift or as a truck-mounted lift. The system facilitates loading a self-propelled (e.g., a spider-style) aerial lift onto a truck chassis via the oversized outriggers of the lift to operate as a truck-mounted lift as well as unloading the self-propelled aerial lift from the truck chassis to operate as a self-propelled lift. The system comprises a deck that may be installed onto a truck chassis. When combined with a self-propelled aerial lift (e.g., a spider-style lift), the system provides a safe, efficient, and easy mechanism for transporting the lift while also enabling an operator to operate the lift directly from the rear of the truck chassis like a conventional truck-mounted lift or as a self-propelled lift as needed.

The inventors have recognized that the system described herein provides many advantages not achievable with previous systems. In particular, the system allows users to operate the lift directly from the truck chassis. Alternatively, the lift may be automatically unloaded from the chassis to operate as a self-propelled lift. Accordingly, the system provides the benefits of both a truck-mounted lift and a self-propelled lift in a single system. As described herein, while operating as a self-propelled lift the lift may be operated indoors or in otherwise limited space locations. The self-propelled lift may be able to enter difficult access sites, including through gates/doors 36″ or more in width. The self-propelled lift may also self-level itself to be operable on steep slopes where a truck-mounted lift could not safely operate. By contrast, when operating as a truck-mounted lift, the lift may be easily transported (e.g., without requiring a lengthy unloading process between transportation and operation).

The system described herein allows for a lift to be automatically loaded and/or unloaded onto the truck chassis in a significantly shorter amount of time as compared to existing systems. For example, the system described herein facilitates completing the loading and/or unloading process in a matter of seconds. In addition, as the system allows for the lift to be automatically loaded and/or unloaded from a truck chassis, only a single operator is necessary to control the loading and/or unloading process in comparison to existing techniques which may require multiple operators to complete the loading and/or unloading process.

The system described herein allows for a lift to be automatically loaded and/or unloaded onto the truck chassis without requiring a user to physically interact with the lift during the loading or unloading process. Accordingly, the user may remain on the ground and a safe distance away from the lift during the unloading and/or unloading process.

The system described herein may be installed on a standard truck chassis. In contrast to the type of vehicles required to transport existing systems, standard trucks are easier to drive and more reasonably priced to purchase, maintain, and insure. The system described herein is universal and capable of fitting the majority of standard trucks including from brands such as FORD®, CHEVROLET®, DODGE®, ISUZU®, HINO®, INTERNATIONAL®, FREIGHTLINER®, etc.

The system described herein may comprise a deck which is low to the ground. The lower deck height of the system presents a number of advantages. In particular, for every inch a vehicle load is above the ground, the stability is incrementally reduced. The higher the deck height of the vehicle and load, the less stable the vehicle. The lower height of the deck of the system therefore provides increased vehicle stability, which is advantageous, for example, in the case of an emergency maneuver. In some embodiments, the height of the system when mounted on a chassis of a standard truck is 32″ above the ground (e.g., when mounted on a chassis of a standard truck with two-wheel drive). In some embodiments, the height of the system when mounted on a chassis of a standard truck is 36″ above the ground (e.g., when mounted on a chassis of a standard truck with four-wheel drive). For example, a truck with four-wheel drive may have 19.5″ tires and rims. By contrast, conventional platforms, when coupled to a truck, are 39″-41″ inches high (for a truck with two-wheel drive) and 43″-45″ high for a truck with four-wheel drive. In either case, the conventional platform height is too high to enable self-loading/self-unloading of a spider-type aerial work platform.

In addition, the relatively low height of the combination of the deck together with a smaller truck chassis means an operator is not required to climb up or down onto the truck deck. By contrast, existing truck-mounted lifts require operators to climb up steps, vault up and down truck decks, and/or walk on slippery platforms or unprotected cab guards. Most self-propelled lifts require an operator to ride the self-propelled lift which places the operator in a dangerous situation, as operators can be ejected from the lift or flip over in the lift while driving the self-propelled lift. The Occupational Safety and Health Administration (OSHA) has a long list of recorded instances of serious injuries resulting while lift operators climb on truck-mounted lifts where they slip and/or lose grip and fall. Even just jumping from a high truck deck onto the ground can cause ankle injuries which may prevent the operator from being able to work.

The relatively low height of the combination of the deck together with a smaller truck chassis also enables the system and lift to easily fit under the majority of bridges (e.g., railroad bridges) in the United States. In particular, the combined height of the truck chassis, deck, and lifts may be less than 9 ft, 6 in.

Traditional lifts in combination with the vehicle which transports the lift may weigh a significant amount (e.g., approximately 40,000 lbs.). A commercial driver's license is required to transport weights of 26,001 lbs. or more in the United States. Accordingly, CDLs, which may be expensive and difficult to obtain, are typically required for transporting existing lifts. The system developed by the inventors in combination with a self-propelled lift may be significantly lighter (e.g., approximately 10,000 lbs.). Accordingly, the system described herein allows for transportation and operation of a lift with a standard driver's license and does not require a CDL.

Accordingly, aspects of the technology described herein provide for a system configured to be installed onto a chassis of a truck, the system comprising: a deck for supporting an aerial lift; and a frame configured to be coupled beneath the deck and mounted onto the chassis of the truck, wherein the system is configured to be removably coupled to the aerial lift. In some embodiments, the deck comprises first and second portions configured to be coupled together. In some embodiments, the frame comprises first and second portions configured to be coupled together. In some embodiments, the frame comprises a ladder configuration. In some embodiments, the frame comprises a pair of vertical bars and a plurality of horizontal bars coupling the pair of vertical bars together.

In some embodiments, the system further comprises a headache bar disposed at a front end of the system. In some embodiments, the system further comprises a rear bumper disposed at a rear end of the system. In some embodiments, the system further comprises one or more D rings for receiving one or more tethers that fasten the aerial lift to the deck. In some embodiments, the system further comprises one or more mounting brackets for mounting the frame to one or more components of the system and/or to the chassis of the truck. In some embodiments, the system further comprises fenders for at least partially covering tires of the chassis. In some embodiments, the system further comprises one or more brackets for securing a respective fender over a respective tire of the chassis.

In some embodiments, the truck comprises a standard truck operable without a commercial driver's license. In some embodiments, the aerial lift comprises a spider-style self-propelled aerial lift. In some embodiments, the aerial lift can be remotely unloaded (e.g., decoupled) from the system. In some embodiments, the aerial lift can be remotely loaded (e.g., coupled) to the system. In some embodiments, the aerial lift can be operated while coupled to the system (e.g., to the deck), wherein operating the aerial lift comprises elevating a compartment of the lift configured to accommodate an operator.

In accordance with some embodiments, there is provided a method for deploying an aerial lift from a system, the system comprising a deck for supporting the aerial lift and a frame configured to be coupled beneath the deck and mounted onto a chassis of a truck, the method comprising: moving one or more outriggers of the aerial lift from a folded configuration to a deployed configuration while the aerial lift is supported by the deck of the system, wherein a distal end of each of the one or more outriggers contact a ground when the aerial lift is in the deployed configuration; and operating the aerial lift while the aerial lift is supported by the deck of the system and the one or more outriggers are in the deployed configuration, wherein operating the aerial lift comprises elevating a compartment of the aerial lift configured to accommodate an operator. In some embodiments, the method further comprises unfastening one or more tethers fastening the aerial lift to the system from the aerial lift.

In accordance with some embodiments, there is provided a method for deploying an aerial lift from a system, the system comprising a deck for supporting the aerial lift and a frame configured to be coupled beneath the deck and mounted onto a chassis of a truck, the method comprising: moving (e.g., remotely) one or more outriggers of the aerial lift from a folded configuration to a deployed configuration while the aerial lift is supported by the deck of the system, wherein a distal end of each of the one or more outriggers contact a ground when the aerial lift is in the deployed configuration; and remotely elevating the aerial lift from the deck of the system by decreasing a bend in respective joints of the one or more outriggers such that the chassis can be removed from under the aerial lift.

In some embodiments, the method further comprises remotely lowering the aerial lift onto the ground by increasing a bend in the respective joints of the one or more outriggers; and moving (e.g., remotely) the one or more outriggers of the aerial lift to the folded configuration. In some embodiments, the method further comprises moving the aerial lift via a track coupled to the aerial lift.

In accordance with some embodiments, there is provided a method for packing an aerial lift for transport via a system, the system comprising a deck for supporting the aerial lift and a frame configured to be coupled beneath the deck and mounted onto a chassis of a truck, the method comprising: remotely elevating the aerial lift (e.g., from the ground) by decreasing a bend in respective joints of one or more outriggers of the lift such that the chassis of the truck can be positioned beneath the aerial lift; lowering the aerial lift onto the deck of the system by increasing a bend in the respective joints of the one or more outriggers of the aerial lift. In some embodiments, the method further comprises moving (e.g., remotely) the one or more outriggers of the aerial lift into a folded configuration. In some embodiments, the method further comprises fastening the aerial lift to the system via one or more tethers.

In accordance with some embodiments, there is provided a system configured to be installed onto a chassis of a truck, the system comprising: a deck; a frame configured to be coupled beneath the deck and mounted onto the chassis of the truck; and first and second plurality of bars coupled to respective opposing sides of the frame, wherein respective ones of the first and second plurality of bars extend in a direction substantially perpendicular to a length and a width of the deck.

In some embodiments, the system further comprises a movable arm coupled to the truck, the movable arm comprising a grapple at an end of the movable arm. In some embodiments, the grapple comprises a pair of opposing jaws. In some embodiments, the movable arm comprises at least one telescoping portion. In some embodiments, the movable arm has at least three degrees of freedom.

In some embodiments, the first and second plurality of bars each comprise at least four bars. In some embodiments, the first and second plurality of bars each comprise at least six bars. In some embodiments, respective ones of the first and second plurality of bars have a length of at least one foot. In some embodiments, respective ones of the plurality of bars are spaced laterally apart from others of the first plurality of bars by at least one foot.

In some embodiments, the system further comprises respective fastening mechanisms coupling respective ones of the first and second plurality of bars to the frame, such that the first and second plurality of bars can be decoupled from the frame.

In some embodiments, the deck comprises first and second portions configured to be coupled together. In some embodiments, the frame comprises first and second portions configured to be coupled together. In some embodiments, the frame comprises a ladder configuration. In some embodiments, the frame comprises a pair of vertical bars and a plurality of horizontal bars coupling the pair of vertical bars together.

In some embodiments, the system further comprises a headache bar disposed at a front end of the system. In some embodiments, the system further comprises a rear bumper disposed at a rear end of the system. In some embodiments, the system further comprises one or more D rings for receiving one or more tethers that fasten the aerial lift to the deck. In some embodiments, the system further comprises one or more mounting brackets for mounting the frame to one or more components of the system and/or to the chassis of the truck. In some embodiments, the system further comprises fenders for at least partially covering tires of the chassis. In some embodiments, the system further comprises one or more brackets for securing a respective fender over a respective tire of the chassis.

In some embodiments, the truck comprises a standard truck operable without a commercial driver's license. In some embodiments, the system is configured to support an aerial lift. In some embodiments, the aerial lift comprises a spider-style self-propelled aerial lift. In some embodiments, the aerial lift can be remotely unloaded (e.g., decoupled) from the system. In some embodiments, the aerial lift can be remotely loaded (e.g., coupled) to the system. In some embodiments, the aerial lift can be operated while coupled to the system (e.g., to the deck), wherein operating the aerial lift comprises elevating a compartment of the lift configured to accommodate an operator.

In accordance with some embodiments, there is provided a method for loading one or more logs onto a system mounted on a chassis of a truck, the system comprising a deck, a frame configured to be coupled beneath the deck and mounted onto the chassis of the truck, first and second plurality of bars coupled to respective opposing sides of the frame, wherein respective ones of the first and second plurality of bars extend in a direction substantially perpendicular to a length and a width of the deck, and a movable arm coupled to the truck and comprising a grapple, the method comprising: moving the movable arm into a position adjacent to a log of the one or more logs; moving jaws of the grapple such that the grapple grasps the log; and moving the log onto the deck by moving the movable arm.

In accordance with some embodiments, there is provided a method for converting a system for supporting an aerial lift comprising a deck and a frame coupled to a chassis of a truck into a system for transporting one or more logs, the method comprising: coupling a first plurality of bars to a first side of the frame, wherein respective ones of the first plurality of bars extend in a direction substantially perpendicular to a length and a width of the deck; and coupling a second plurality of bars to a second side of the frame opposing the first side, wherein respective ones of the second plurality of bars extend in the direction substantially perpendicular to the length and the width of the deck.

In some embodiments, the coupling comprises inserting respective ones of the first and second plurality of bars into respective openings in the frame and fastening the respective ones of the first and second plurality of bars to the frame with respective fastening mechanisms. In some embodiments, the first and second plurality of bars each comprise at least four bars. In some embodiments, the first and second plurality of bars each comprise at least six bars.

In some embodiments, the method further comprises extending a width of the frame at least in part by coupling a third plurality of bars to the frame on the first side of the frame, wherein respective ones of the third plurality of bars extend in a direction along the width of the frame and coupling a fourth plurality of bars to the frame on the second side of the frame, wherein respective ones of the fourth plurality of bars extend in the direction along the width of the frame. In some embodiments, coupling the first plurality of bars to the frame comprises coupling the first plurality of bars to the third plurality of bars and coupling the second plurality of bars to the frame comprises coupling the second plurality of bars to the fourth plurality of bars.

According to some embodiments, there is provided a system comprising: a self-propelled aerial lift having a plurality of outriggers configured to support the aerial lift relative to a surface; a kit configured to be installed on a chassis of a truck, the kit comprising: a deck for supporting the self-propelled aerial lift; and a frame configured to be coupled beneath the deck and mounted onto the chassis of the truck, wherein the system is configured to be removably coupled to the aerial lift, and wherein a width of the frame and a width of the deck are each less than a width between rear tires of the chassis such that the deck and the frame are disposed between the rear tires of the chassis when the kit is installed on the chassis of the truck.

In some embodiments, the width of the frame is 34 inches or less. In some embodiments, the width of the deck is 34 inches or less.

In some embodiments, the deck is configured to: support the self-propelled aerial lift during operation of the self-propelled aerial lift, wherein operating the self-propelled aerial lift comprises elevating a compartment of the self-propelled aerial lift configured to accommodate an operator; permit the self-propelled aerial lift to remove itself from the deck; and permit the self-propelled aerial lift to load itself onto the deck.

In some embodiments, the deck comprises first and second portions configured to be coupled together. In some embodiments, the frame comprises first and second portions configured to be coupled together.

In some embodiments, the kit further comprises a headache bar configured to be coupled to a front end of the frame. In some embodiments, the kit further comprises a rear bumper configured to be coupled to a rear end of the frame. In some embodiments, the kit further comprises one or more D rings for receiving one or more tethers that fasten the self-propelled aerial lift to the deck. In some embodiments, the kit further comprises fenders for at least partially covering the rear tires of the chassis. In some embodiments, the kit further comprises one or more brackets for securing a respective fender over a respective tire of the chassis. In some embodiments, the kit further comprises one or more mounting brackets for mounting the frame to one or more components of the kit and/or to the chassis of the truck.

In some embodiments, the truck comprises a standard truck operable without a commercial driver's license.

In some embodiments, the frame comprises a ladder configuration. In some embodiments, the frame comprises a pair of vertical bars and a plurality of horizontal bars coupling the pair of vertical bars together.

In some embodiments, the kit further comprises a first and second plurality of bars coupled to respective opposing sides of the frame, wherein respective ones of the first and second plurality of bars extend in a direction substantially perpendicular to the width of the deck and a length of the deck. In some embodiments, the kit further comprises a movable arm coupled to the truck, the movable arm comprising a grapple at an end of the movable arm. In some embodiments, the grapple comprises a pair of opposing jaws. In some embodiments, the movable arm comprises at least one telescoping portion. In some embodiments, the movable arm comprises at least three degrees of freedom. In some embodiments, the first and second plurality of bars comprise at least four bars. In some embodiments, respective ones of the first plurality of bars have a length of at least 1 foot and are spaced laterally apart from others of the first plurality of bars by at least one foot.

In some embodiments, the self-propelled aerial lift comprises a spider-style self-propelled aerial lift.

According to some embodiments, there is provided a method for use with a self-propelled aerial lift, the method comprising: moving one or more outriggers of the self-propelled aerial lift from a folded configuration to a deployed configuration while the self-propelled aerial lift is supported by a deck of a system mounted on a chassis of a truck, wherein a distal end of each of the one or more outriggers at least partially supports the self-propelled aerial lift relative to a surface when the one or more outriggers are in the deployed configuration; operating the self-propelled aerial lift while the self-propelled aerial lift is supported by the deck of the system and the one or more outriggers are in the deployed configuration, wherein operating the self-propelled aerial lift comprises elevating a compartment of the self-propelled aerial lift configured to accommodate an operator; and unloading the self-propelled aerial lift from the deck of the system by remotely elevating the self-propelled aerial lift from the deck of the system such that the self-propelled aerial lift supports itself over the deck of the system and the deck can be removed from under the self-propelled aerial lift.

In some embodiments, the method further comprises unfastening one or more tethers fastening the self-propelled aerial lift to the system from the self-propelled aerial lift.

In some embodiments, the method further comprises subsequent to unloading the self-propelled aerial lift from the deck of the system, remotely lowering the aerial lift onto the ground; and moving the one or more outriggers of the aerial lift to the folded configuration.

In some embodiments, the method further comprises moving the self-propelled aerial lift via a track coupled to the self-propelled aerial lift.

According to some embodiments, there is provided a method for use with a self-propelled aerial lift, the method comprising: loading the self-propelled aerial lift onto a deck of a system coupled to a chassis of a truck, by: remotely elevating the self-propelled aerial lift such that the chassis of the truck can be positioned beneath the self-propelled aerial lift; and lowering the self-propelled aerial lift onto the deck of the system such that the self-propelled aerial lift is supported by the deck of the system; and operating the self-propelled aerial lift while the self-propelled aerial lift is supported by the deck of the system and one or more outriggers are in a deployed configuration where a distal end of each of the one or more outriggers at least partially supports the self-propelled aerial lift relative to a surface, wherein operating the self-propelled aerial lift comprises elevating a compartment of the self-propelled aerial lift configured to accommodate an operator.

According to some embodiments, the method further comprises, subsequent to loading the self-propelled aerial lift onto the deck of the system: moving the one or more outriggers of the self-propelled aerial lift from the deployed configuration to a folded configuration and transporting the self-propelled aerial lift with the truck.

According to some embodiments, the method further comprises fastening the self-propelled aerial lift to the system via one or more tethers.

The aspects and embodiments described above, as well as additional aspects and embodiments, are described further below. These aspects and/or embodiments may be used individually, all together, or in any combination, as the technology is not limited in this respect.

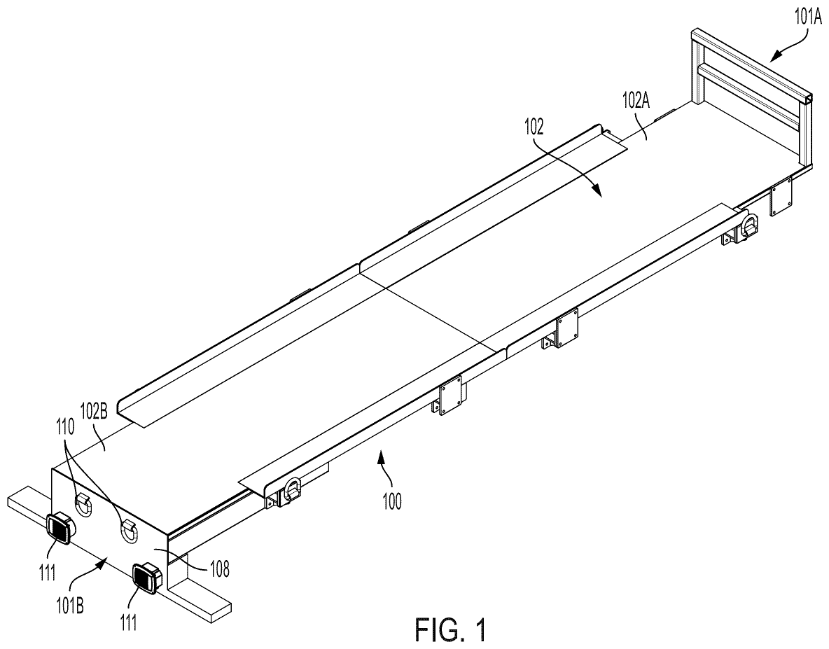

FIG. 1 illustrates an example system 100 for facilitating loading, transporting, and unloading a self-propelled lift, in accordance with some embodiments of the technology described herein. The system 100 may be coupled to a vehicle chassis (e.g., a truck) and used for transporting a lift, such as a self-propelled aerial lift, as described herein. A front end 101A of the system 100 may be disposed adjacent to a cab of the vehicle where a driver sits. A rear end 101B of the system 100 may be disposed adjacent to a rear end of the vehicle chassis.

As described herein, the system 100 may be used to transport a self-propelled aerial lift. The system 100 comprises a deck 102 for supporting a lift thereon during operation of the lift.

In the illustrated embodiment, the deck comprises a first portion 102A and a second portion 102B. During assembly of the system 100, the first portion 102A (e.g., a front portion) and the second portion 102B (e.g., a rear portion) of the deck 102 may be coupled together. For example, in some embodiments, the first portion and the second portion 102A-B of the deck 102 are welded together. In the illustrated embodiment, the first portion and the second portion 102A-B of the deck are bolted together (e.g., via ½ ″bolts). In some embodiments, the first and second portions of the deck 102A-B may be coupled (e.g., bolted, welded) to another component (e.g., the frame 104). The inventors have recognized that configuring the deck 102 in two portions 102A-B may make shipping, transporting, or otherwise handling the system 100 easier. However, in some embodiments, the deck 102 may comprise a single integral piece. In some embodiments, the deck 102 may comprise more than two portions which may be coupled together.

In some embodiments, the first and second portions 102A-B may be equal in dimension (e.g., height, width, and/or thickness). For example, in some embodiments, the first and second portions 102A-B of the deck 102 may have a combined length of approximately 8 ft. The length of the deck and/or frame may be configured to be a suitable length for supporting an aerial lift. In some embodiments, the length of the deck and/or frame may be greater than a length of the chassis of the truck, such that the deck and/or frame extends past a rear end of the chassis when the system is mounted to the chassis. In some embodiments, each of the first and second portions 102A-B of the deck 102 may have a width of approximately 34 inches. The inventors have recognized that designing the deck 102 and frame with a width of approximately 34 inches, or 34 inches or less, facilitates use of the system with most trucks (e.g., FORD®, CHEVROLET®, DODGE®, ISUZU®, HINO®, INTERNATIONAL®, FREIGHTLINER®, etc.). The width of the deck 102 and frame may be less than a width between rear tires of the chassis of standard truck (e.g., a truck that does not require a commercial license to drive), such that when the system is installed onto the chassis of the truck, the deck and frame are disposed between the rear tires of the chassis.

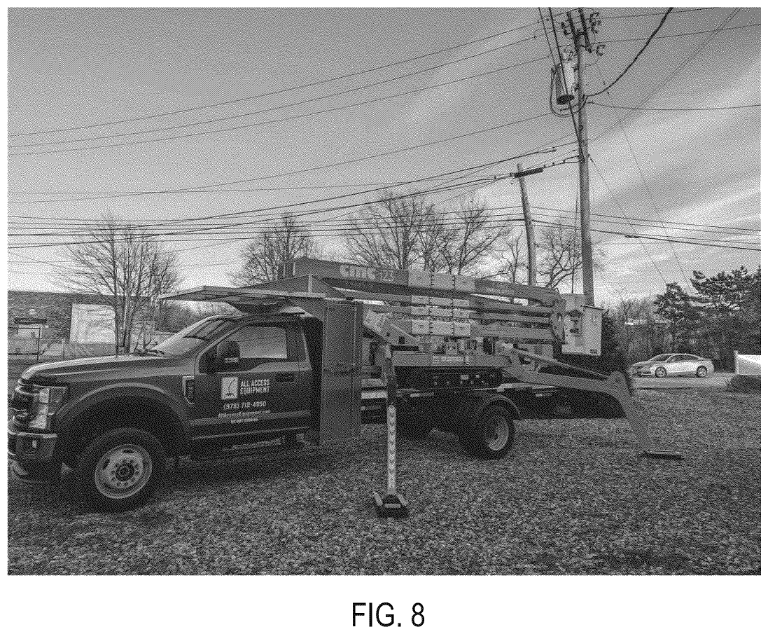

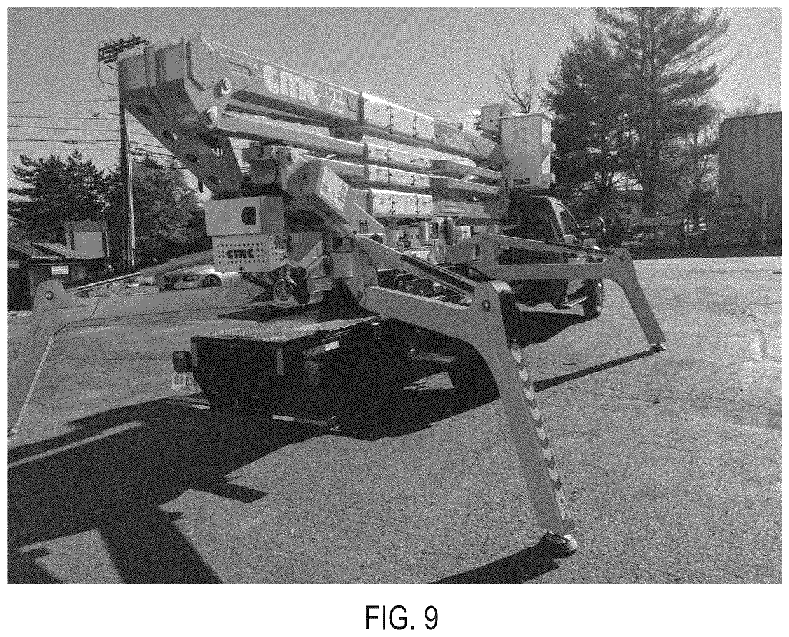

The relatively small width of the system can facilitate use of an aerial lift with the system. For example, as described herein, the aerial lift may comprise a plurality of outriggers that contact a surface (e.g., the ground) and support the aerial lift relative to the surface. The aerial lift may also be elevated from the deck of the system by reducing a bend in joints of the plurality of outriggers. By reducing the width of the system, it may be easier for the outriggers to be moved to a deployed configuration where the outriggers contact the ground (e.g., as shown in FIGS. 8-9). The outriggers may have a reduced size facilitated by the reduced width of the system. In addition, the reduced width of the deck may provide more clearance for the aerial lift to be loaded onto and off of the deck, making the unloading and loading of the aerial lift easier.

The deck 102 may be made of any suitable material capable of supporting a lift thereon. For example, in some embodiments, the deck 102 comprises aluminum. The deck 102 may comprise a slip resistant material (e.g., aluminum) to decrease the chance of an operator becoming injured when interacting with the deck 102.

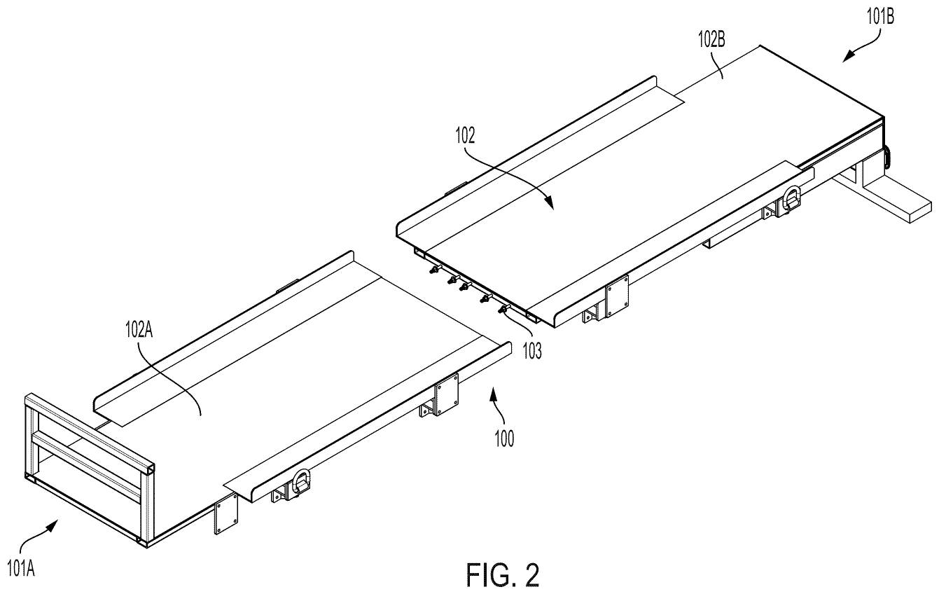

FIG. 2 illustrates the example system of FIG. 1 with the first and second portions 102A-B of the deck 102 separated, in accordance with some embodiments of the technology described herein. As described herein, in some embodiments, first and second portions 102A-B of the deck 102 may be coupled together. In the illustrated embodiment of FIG. 2, an underlying frame 104 of the system 100 to which first and second portions of the deck 102 are each coupled (e.g., via welding) is coupled together thereby coupling the first and second portions 102A-B of the deck 102. In the illustrated embodiment of FIG. 2, the portions of the frame 104 are bolted together via ½ ″ bolts 103.

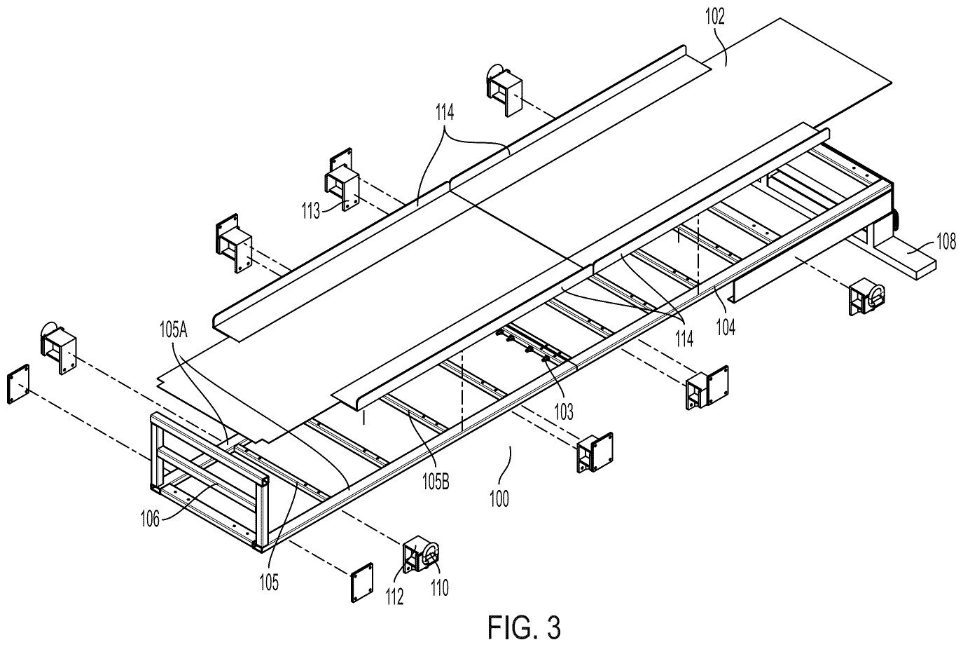

FIG. 3 illustrates an exploded view of the example system of FIG. 1, in accordance with some embodiments of the technology described herein. FIG. 3 illustrates frame 104 on which deck 102 may be positioned and/or coupled to. In some embodiments, deck 102 (including first and/or second portions 102A-B thereof) may be welded to the frame in one or more locations. In some embodiments, deck 102 (including first and/or second portions 102A-B thereof) may be otherwise coupled to the frame (e.g., via bolts).

In the illustrated embodiment, frame 104 comprises a first portion 104A (e.g., a front portion) and a second portion 104B (e.g., a rear portion). Similar to first and second portions 102A-B of the deck 102, first and second portions 104A-B of the frame 104 may be coupled together. In some embodiments, first and second portions 104A-B of the frame 104 are welded together. In some embodiments, first and second portions 104A-B of the frame 104 are coupled together with a fastener, such as one or more bolts. In the illustrated embodiment, first and second portions 104A-B of the frame 104 are bolted together via a plurality of bolts 103. Although the frame 104 is shown in the illustrated embodiment comprising two portions, in some embodiments, the frame may comprise a single integral piece. In some embodiments, the frame 104 may comprise more than two portions which may be coupled together.

Frame 104 may comprise a ladder configuration, as shown in FIG. 3. For example, Frame 104 may comprise a plurality of horizontal bars 105B which are substantially perpendicular to a pair of vertical bars 105A running along the length of the plurality of horizontal bars 105B. Bars 105A-B may comprise steel tubes, in some embodiments. The pair of vertical bars 105A are coupled together via the plurality of horizontal bars 105B. In some embodiments, one or more of the bars 105A-B may be welded together. In some embodiments, one or more of the bars 105A-B may be coupled together via one or more fasteners, such as bolts (e.g., ½ ″bolt(s)).

Vertical bars 105A may be approximately 8 ft long. In some embodiments, one or more of bars 105A-B are ¼ inch thick. In some embodiments, the frame 104 may have a width of approximately 34 inches. The inventors have recognized that designing the frame 104 with a width of approximately 34 inches facilitates use of the system 100 with most trucks (e.g., FORD®, CHEVROLET®, DODGE®, ISUZU®, HINO®, INTERNATIONAL®, FREIGHTLINER®, etc.). For trucks with a chassis of a smaller width, shims may be implemented at points where the frame 104 attaches to the truck chassis.

In some embodiments, the system 100 may comprise a headache rack 106 coupled to the frame 104 at the front end 101A of the system 100. When a lift is transported using the system 100, the headache rack 106 may prevent the lift from contacting the cab of the vehicle if the lift becomes untethered from the system 100. Accordingly, the headache rack 106 provides an important safety feature for the system 100.

In some embodiments, the headache rack 106 is welded to the frame 104 (e.g., to first portion 104A). In some embodiments, the headache rack 106 is coupled to the frame 104 (e.g., to first portion 104A) via one or more fasteners (e.g., one or more bolts). In some embodiments, the headache rack 106 is integral with the frame 104 (e.g., with first portion 104A).

In some embodiments, the headache rack 106 has a height of approximately 16″. In some embodiments, the headache rack 106 has a width of approximately 34″. However, other dimensions of the headache rack 106 are possible.

As shown in the illustrated embodiments, the system 100 may comprise a rear frame portion 108. The rear frame portion 108 is disposed at the rear end 101B of the system adjacent to a rear end of the truck chassis. The rear frame portion 108 may comprise a tow bar and Interstate Commerce Commission (ICC) bumper coupled (e.g., welded) together. The rear frame portion 108 may comprise steel. In some embodiments, the rear frame portion 108 may have a length (e.g., depth) of ¼ “, a height of 8”, and/or a width of 48″.

In some embodiments, the rear frame portion 108 is welded to the frame 104 (e.g., to second portion 104B). In some embodiments, the rear frame portion 108 is coupled to the frame 104 (e.g., to second portion 104B) via one or more fasteners (e.g., one or more bolts). In some embodiments, the rear frame portion 108 is integral with the frame 104 (e.g., with second portion 104B).

In some embodiments, the rear frame portion 108 may be equipped with one or more additional features. For example, as shown in FIG. 1, the rear frame portion 108 may comprise one or more rear lights 111. In some embodiments, the rear frame portion 108 may comprise one or more pre-drilled holes for additional or alternative lights to rear lights 111 (e.g., Department of Transportation identification lights, license plate light). In some embodiments, the rear frame portion 108 comprises license plate mounting hole(s), back-up camera mounting bracket(s), receiver tube(s) for a towing hitch, marker light(s), inlet pipe(s) for a fuel tank, and/or cut-out(s) for a trailer electric plug.

In some embodiments, the system 100 further comprises lateral extension plates 114. The lateral extension plates 114 may comprise a plate with a lip which extends along a length of the system 100. In the illustrated embodiment, the system 100 comprises four lateral extension plates 114 coupled (e.g., welded, bolted, or otherwise fastened) to the deck 102 and/or frame 104. For example, each of the sides of each of the first and second portions 102A-B of the deck 102 are coupled to a respective lateral extension plate 114. However, in other embodiments, a different number of lateral extension plates 114 may be implemented.

In some embodiments, the lateral extension plates 114 comprise steel. The lateral extension plates 114 may comprise an anti-slip surface which reduces the chance of operator injury when an operator interacts with the system 100.

As described herein, components of the system 100 may be coupled together and/or to a truck chassis. The system 100 may comprise mounting brackets 113 and/or stanchions 112 for facilitating this coupling. For example, mounting brackets 113 may be provided coupling frame 104, the truck chassis, deck 102, and/or lateral extension plates 114 together. Fasteners, such as bolts, may be used with each mounting bracket 113 to couple components of the system 100 together and/or to the truck chassis. In some embodiments, mounting brackets 113 may be welded to one or more components (e.g., one or more components of the system 100 and/or the truck chassis). In the illustrated embodiments, a plurality of mounting brackets 113 are implemented on each lateral side of the system 100, however, any suitable number of mounting brackets 113 may be implemented.

In some instances, such as when coupling frame 104 to lateral extension plates 114, stanchions 112 may be implemented to facilitate coupling while accounting for the lateral offset between frame 104 and lateral extension plates 114. For example, as shown in the figures, stanchions 112 extend laterally outwards.

As described herein, the system 100 may be used to transport a lift. In some embodiments, the lift may be secured to the system 100 via one or more tethers. Tethers may be secured to the system 100, including to frame 104 and/or deck 102 via one or more D rings 110. In the illustrated embodiment, the system comprises a plurality of D rings 110 disposed on the sides and rear of the system 100. Any suitable number of D rings 110 may be implemented in any suitable location. In the illustrated embodiment, the D rings are 6″ in diameter.

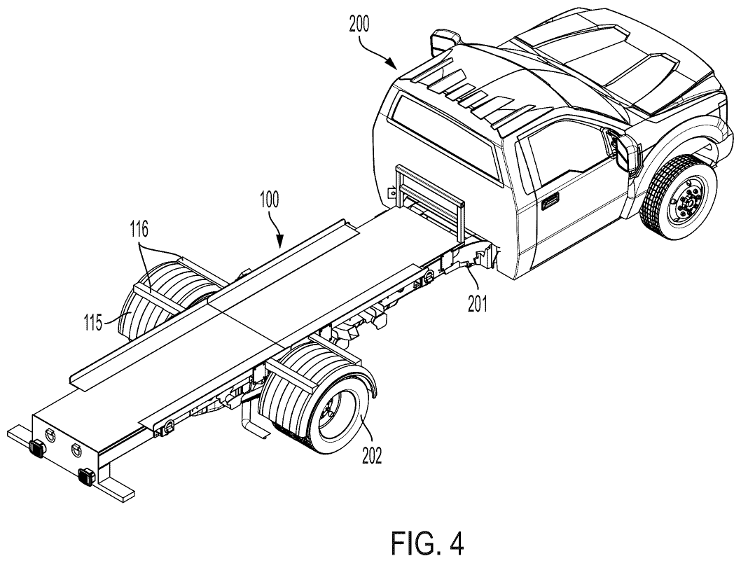

FIG. 4 illustrates the example system of FIG. 1 being installed on a chassis 201 of a truck 200, in accordance with some embodiments of the technology described herein. As described herein, the truck 200 may be a standard truck which can be operated with a standard driver's license as opposed to requiring a CDL. For example, the truck 200 may be a standard truck from a brand such as FORD®, CHEVROLET®, DODGE®, ISUZU®, HINO®, INTERNATIONAL®, FREIGHTLINER®, etc.

As described herein, the system 100 may be installed onto the chassis 201 of the truck 200. For example, frame 104 (including one or more of bars 105A-B) may be coupled to the chassis 201 (e.g., via welding or other fastening). In some embodiments, the frame 104 may be bolted to the chassis 201 (e.g., via one or more ½ ″bolts).

As shown in FIG. 4, the system 100 may comprise fenders 115 which partially cover rear tires 202 of the chassis 201. Fenders 115 may prevent the spread of dirt or other debris picked up by tires 202. The fenders 115 may comprise plastic, in some embodiments. The fenders 115 may be coupled to system 100 (e.g., to frame 104, deck 102, and/or, in the illustrated embodiments, lateral extension plates 114) via fender brackets 116. In the illustrated embodiment, the system comprises two fender brackets 116 per fender 115, though any suitable number of fender brackets 116 may be implemented.

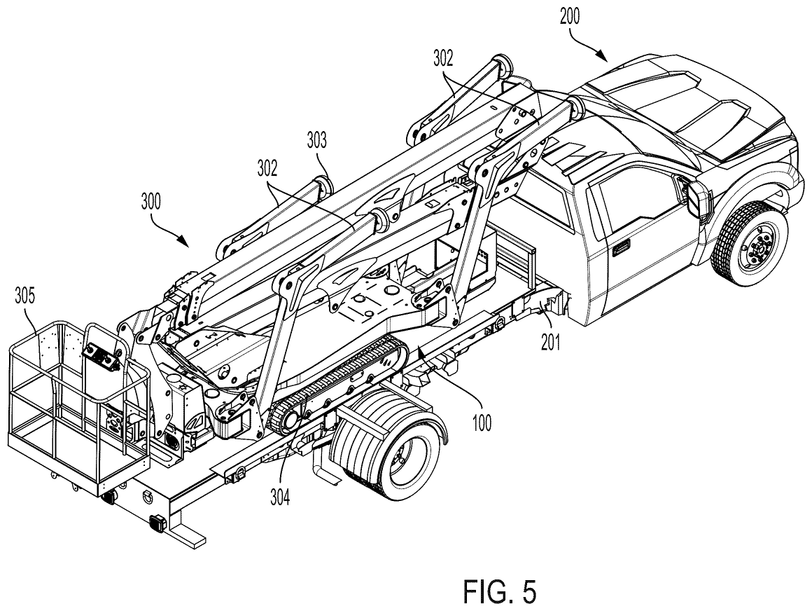

FIG. 5 illustrates a perspective view of the example system of FIG. 1 being installed on a truck chassis 201 with a self-propelled lift 300 loaded thereon, in accordance with some embodiments of the technology described herein.

Lift 300 comprises a compartment 305 (e.g., a bucket) for an operator. The lift 300 may elevate the compartment 305 so that the operator can access an area at a high elevation (e.g., up to 100 ft), such as trees, buildings, and/or electrical lines. The lift 300 may be self-propelled. Accordingly, lift 300 comprises propulsion track 304 which allows the lift 300 to move around on its own without the assistance of truck 200.

In some embodiments, the lift may comprise an insulated lift. In some embodiments, the lift may comprise an uninsulated lift.

The lift 300 may be a spider-style aerial lift. As such, the lift may comprise outriggers 302 which extend from a center of the lift 300 and contact the ground for stability. Accordingly, the lift 300 may have multiple points of contact with the ground, including via each of the outriggers 302 and/or the propulsion track 304. Each of the outriggers 302 may comprise outrigger pads 303 at ends of the outriggers 302 which contact the ground. In the illustrated embodiment, the outriggers 302 are shown in a folded configuration suitable for transport. When the lift is deployed, the outriggers 302 may be unfolded into a deployed position and the outrigger pads 303 may contact the ground. The lift 300 of the illustrated embodiment comprises four spider-style outriggers 302, however other suitable numbers of outriggers 302 are possible. The outriggers 302 comprise joints which allow the outriggers to bend. Adjusting the bend in the joints of the outriggers 302 allow the lift to transition between the folded configuration shown in FIG. 4 and an open configuration when deployed as well as allowing the lift to be elevated or lowered.

When the lift is to be deployed, one or more of the following acts may be performed: (1) place the truck 200 into a stationary position (e.g., in park); (2) unfasten tethers fastening the lift to the system 100 from the lift and/or from the system/truck; (3) move (e.g., remotely via an automated control process) the outriggers of the lift from the folded configuration to a deployed configuration, where each of the outrigger pads contact the ground; (4) elevate the lift from the truck chassis by at least partially unbending (e.g., reducing a bend in) the outrigger joints; (5) move the truck and chassis away from the lift (e.g., by driving the truck and chassis out from under the lift); (6) lower the lift to the ground such that the propulsion track contacts the ground by increasing a bend in the outrigger joints; (7) transition outriggers of the lift to a folded position; and/or (8) move the lift locally via propulsion track. One or more of the above acts may be optional. For example, in some instances, it may be desired to operate the lift in the place where the truck is stationed. Accordingly, one or more of acts 4-8 may not performed. In some embodiments, one or more (e.g., all) of the acts described above may be performed automatically and/or remotely. Accordingly, an operator may not need to physically interact with the lift during deployment.

When the lift is to be moved to an undeployed position (e.g., for transport), one or more of the following acts may be performed: (1) place the lift in a stationary position (e.g., by preventing propulsion track from moving); (2) move (e.g., remotely, via an automated control process) the outriggers of the lift from a folded configuration to a deployed configuration, where each of the outrigger pads contact the ground; (3) elevate the lift from the ground by at least partially unbending (e.g., reducing a bend in) the outrigger joints; (4) move the truck and chassis towards the lift, so that the lift is above the chassis; (5) lower the lift onto the chassis by increasing a bend in the outrigger joints; (6) move the outriggers of the lift to a folded configuration; (7) fasten the lift to the system via one or more tethers; and/or (8) transport the lift via the truck by driving the truck. One or more of the above acts may be optional. In some embodiments, one or more (e.g., all) of the acts described above may be performed automatically and/or remotely. Accordingly, an operator may not need to physically interact with the lift during packing of the lift for transport or storage.

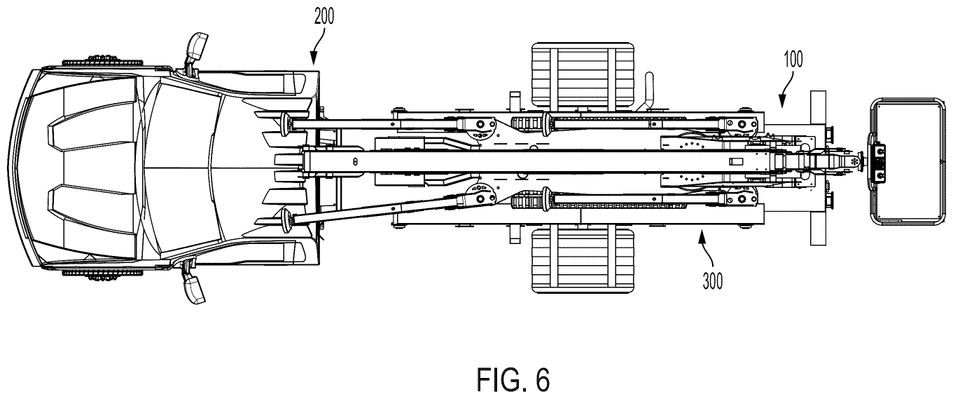

FIG. 6 illustrates a top view of the example system of FIG. 1 being installed on a truck chassis with a self-propelled lift loaded thereon, in accordance with some embodiments of the technology described herein.

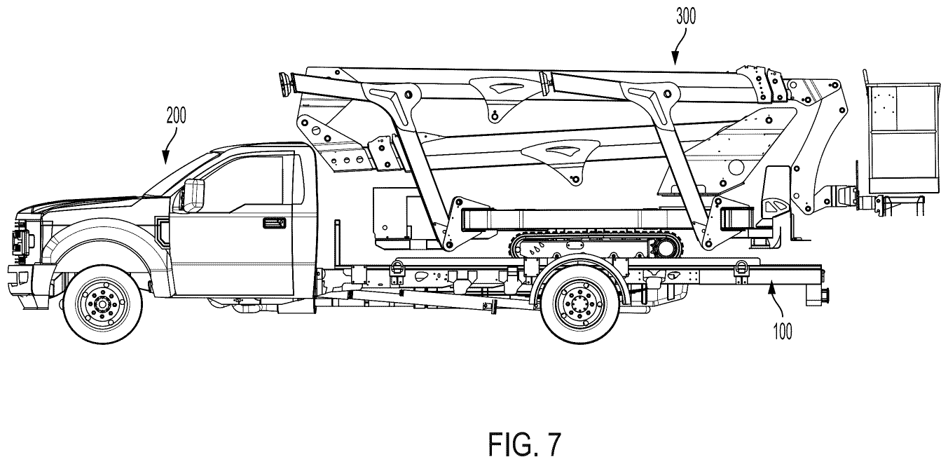

FIG. 7 illustrates a side view of the example system of FIG. 1 being installed on a truck chassis with a self-propelled lift loaded thereon, in accordance with some embodiments of the technology described herein. FIGS. 5-7 illustrate the aerial lift in a folded configuration.

FIG. 8 illustrates an example of a self-propelled lift loaded onto the example system of FIG. 1 and in the process of being deployed, in accordance with some embodiments of the technology described herein.

FIG. 9 illustrates another example of a self-propelled lift loaded onto the example system of FIG. 1 and in the process of being deployed, in accordance with some embodiments of the technology described herein.

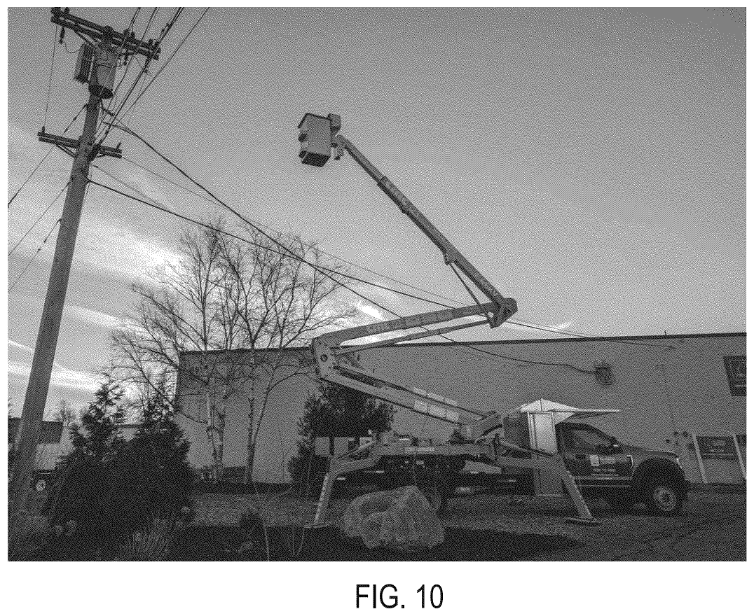

FIG. 10 illustrates an example of a self-propelled lift loaded onto the example system and operating in a deployed position as a truck-mounted lift, in accordance with some embodiments of the technology described herein.

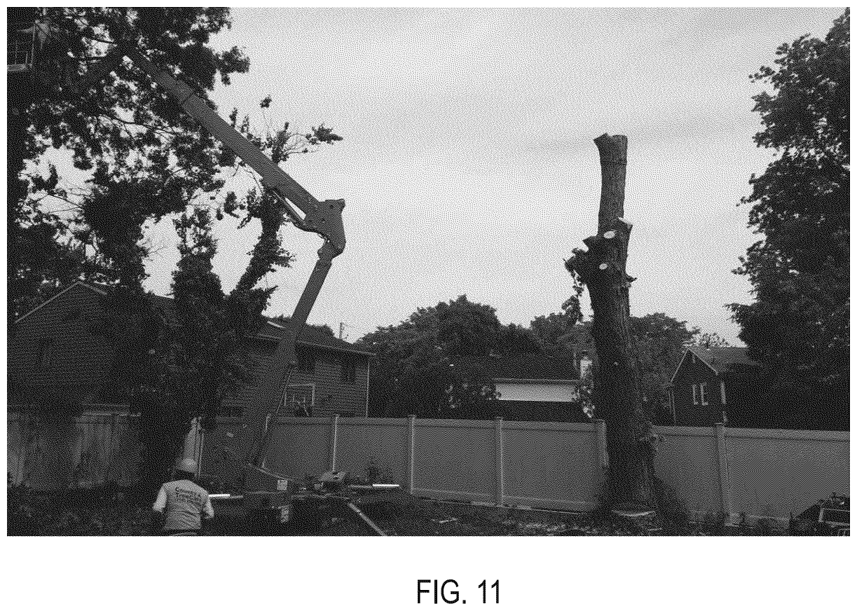

FIG. 11 illustrates an example of a self-propelled lift operating in a deployed position as a self-propelled lift, in accordance with some embodiments of the technology described herein.

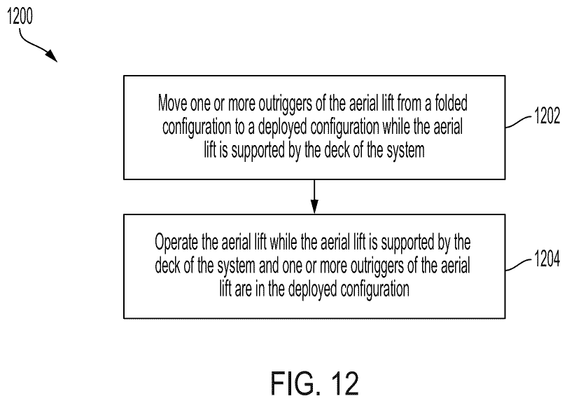

Methods for use with the system are described herein. FIG. 12 illustrates an example method 1200 for deploying an aerial lift from a system, in accordance with some embodiments of the technology described herein. Method 1200 may begin at act 1202 where one or more outriggers of an aerial lift are moved from a folded configuration to a deployed configuration while the aerial lift is supported by a deck of the system. The one or more outriggers may contact the ground in the deployed position. In some embodiments, act 1202 is performed remotely (e.g., via remote control operation such that a user need not interact physically with the system). In some embodiments, act 1202 may be performed automatically in response to a single indication (e.g., a push of a button). At act 1204, the aerial lift is operated while the aerial lift is supported by the deck of the system and the one or more outriggers of the aerial lift is in the deployed configuration. Operating the aerial lift may comprise elevating a compartment of the aerial lift configured to accommodate an operator. In some embodiments, the method 1200 may further comprise unfastening one or more tethers fastening the aerial lift to the system (e.g., prior to act 1202).

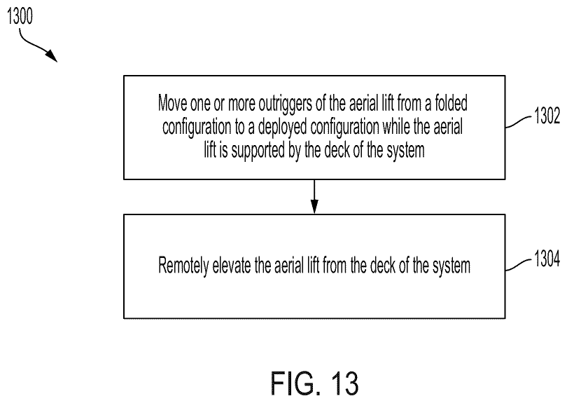

FIG. 13 illustrates an example method 1300 for deploying an aerial lift from a system, in accordance with some embodiments of the technology described herein. Method 1300 may begin at act 1302 where the one or more outriggers of the aerial lift are moved from a folded configuration to a deployed configuration while the aerial lift is supported by the deck of the system. The one or more outriggers of the aerial lift may contact the ground in the deployed configuration. In some embodiments, act 1302 is performed remotely. At act 1304, the aerial lift may be remotely elevated from the deck of the system. For example, the aerial lift may be elevated by decreasing a bend in respective joints of the one or more outriggers such that the chassis of the truck can be removed from under the aerial lift. In some embodiments, method 1300 further comprises removing the chassis from underneath the aerial lift. In some embodiments, the method 1300 further comprises remotely lowering the aerial lift onto the ground by increasing a bend in the respective joints of the one or more outriggers; and moving the one or more outriggers of the aerial lift to the folded configuration. In some embodiments, the method 1300 further comprises moving the aerial lift via a track coupled to the aerial lift (e.g., a self-propelled track).

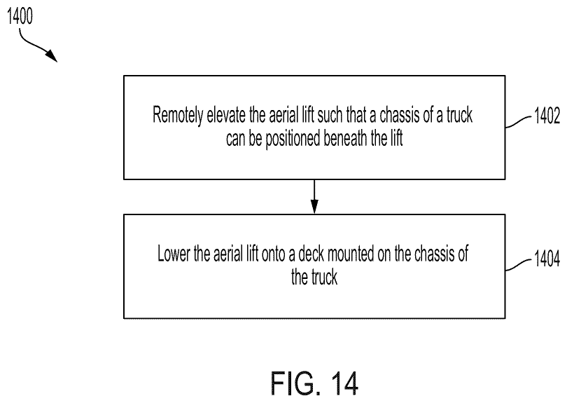

FIG. 14 illustrates an example method 1400 for packing an aerial lift for transport via a system, in accordance with some embodiments of the technology described herein. The method 1400 may begin at act 1402 where the aerial lift is remotely elevated such that the chassis of the truck having the system mounted thereon can be positioned beneath the aerial lift. In some embodiments, elevating the aerial lift comprises decreasing a bend in respective joints of one or more outriggers of the aerial lift. At act 1404, the aerial lift may be lowered onto a deck of the system which is mounted on the chassis of the truck. In some embodiments, lowering the aerial lift comprises increasing a bend in the respective joints of the one or more outriggers of the aerial lift. In some embodiments, the method 1400 further comprises moving the one or more outriggers of the lift into a folded configuration (e.g., subsequent to act 1404). Moving the one or more outriggers to the folded configuration may be performed remotely. In some embodiments, the method 1400 further comprises fastening the aerial lift to the system via one or more tethers. (e.g., subsequent to act 1404 and/or moving the one or more outriggers to the folded configuration).

According to some aspects of the technology described herein, there is provided a system for use as a log truck. In particular, a system for facilitating loading, transporting, and unloading a self-propelled lift, such as system 100 described herein, may be adapted for use as a log truck. The system for use as a log truck described herein provides a single system which allows for easily transitioning between use as a log truck and use for loading, transporting, and unloading a self-propelled lift. The system described herein provides for the ability to transport up to 10,000 lbs. of logs.

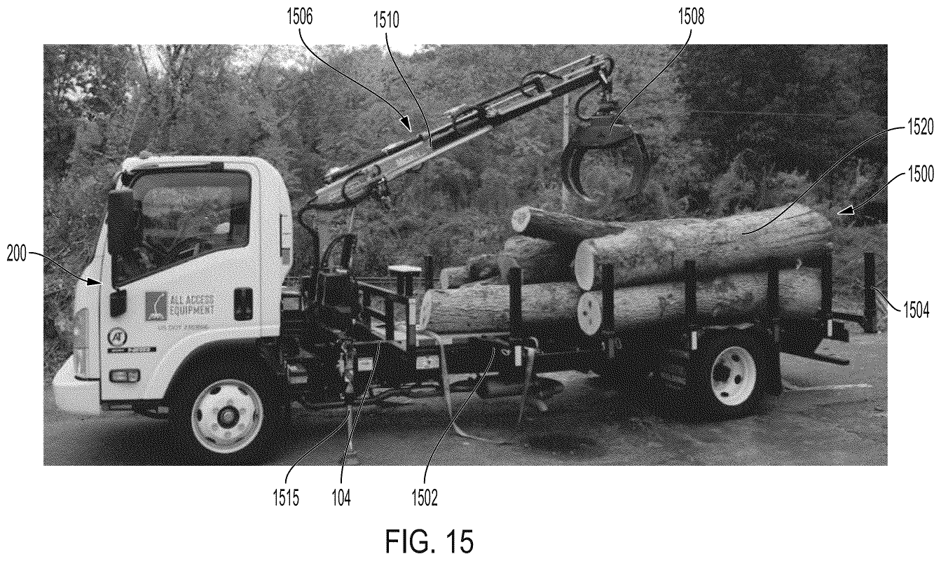

FIG. 15 illustrates aspects of a system 1500 for use as a log truck, in accordance with some embodiments of the technology described herein. In particular, the system 1500 may be used with a vehicle, such as truck 200 to transport one or more logs 1520. The system 1500 may comprise the system 100 for facilitating, loading, transporting, and unloading a self-propelled lift in its entirety or one or more components of the system 100. For example, in the illustrated embodiment of FIG. 15, the system 1500 comprises the deck 102 and frame 104. The components of system 100 which are included in system 1500, such as deck 102 and frame 104 may be configured in system 1500 as described herein with respect to system 100, or one or more components may be configured differently.

In order to convert the system 100 for loading, transporting, and unloading a self-propelled lift into a system for use as a log truck, vertical bars 1504 are coupled to the system 100 to secure any logs loaded onto the system 1500. In the illustrated embodiment of FIG. 15, a plurality of vertical bars 1504 are coupled to the frame 104. For example, a first plurality of vertical bars 1504 are coupled to a first side of the frame 104 and a second plurality of vertical bars 1504 are coupled to a second side of the frame 104 opposite from the first side. The vertical bars extend upwards in a direction that is substantially perpendicular to a length and a width of the deck and frame. In the illustrated embodiment, six vertical bars are coupled to each side of the frame, however any suitable number of vertical bars 1504 may be implemented (e.g., at least one, at least two, at least three, at least four, at least five, at least six).

The vertical bars 1504 each have a length which extends in the direction substantially perpendicular to the length and width of the deck and frame. Accordingly, the plurality of vertical bars 1504 act to increase a height of the frame. The respective vertical bars may have any suitable length (e.g., at least 1 ft, at least 2 ft, at least 3 ft, between 24 inches and 32 inches). Respective ones of the vertical bars 1504 may be spaced apart along each side of the frame 104 (e.g., by at least 1 ft, at least 2 ft, at least 3 ft, at least 4 ft, in some embodiments). In the illustrated embodiment, the frame has a length of 16 ft, and each side of the frame comprises six bars spaced equidistantly apart (e.g., approximately 4 ft apart). The vertical bars 1504 may be made of any suitable material (e.g., steel). In some embodiments, the vertical bars 1504 may be made of a same material as the frame 104.

The inventors have recognized that it may be advantageous to increase the space available on the system for carrying the one or more logs. For example, as described herein, the deck of the system 100 may be sized having a width that is large enough to support an aerial lift. However, to support a greater amount and/or size of logs, it may be advantageous to effectively increase the width of the system 100. In the illustrated embodiment, a plurality of horizontal bars 1502 are coupled to the frame to increase the width of the system 1500. The horizontal bars 1502 extend in a direction along a width of the deck 102 and frame 104.

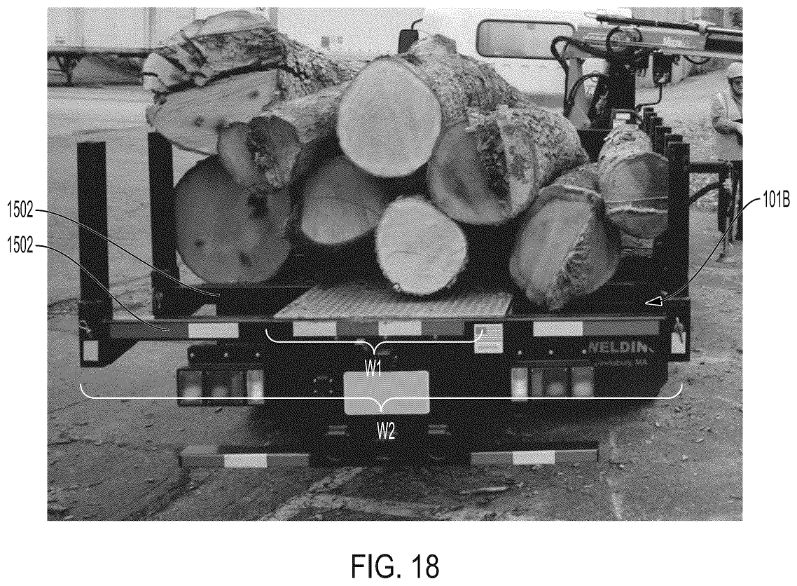

FIG. 18 illustrates a rear view of the system of FIG. 15, in accordance with some embodiments of the technology described herein. As shown in FIG. 18, the deck 102 of the system 100 may have a width of W1. Horizontal bars 1502 may be coupled to opposing sides of the frame 104 to increase the width of the system to a width of W2, as shown in FIG. 18. The increased width W2 of system 1500 may be at least 72 inches in some embodiments. Width W2 may be at least 78 inches in some embodiments. Width W2 may be at least 84 inches in some embodiments. Accordingly, each horizontal bar may be approximately 25 inches in length. The horizontal bars may approximately rectangular in shape, having two faces that are approximately square in shape (e.g., 3 inches by 3 inches).

Horizontal bars 1502 may be coupled to the frame in any suitable manner. For example, in some embodiments, the horizontal bars 1502 may be removably coupled to the frame 104. In some embodiments, horizontal bars 1502 may be welded to the frame 104. In some embodiments, one or more of the horizontal bars 1502 may form an integral component with a component of the system 100 (e.g., with headache rack 106, with rear frame portion 108).

Any suitable number of horizontal bars 1502 may be coupled to the system. In the illustrated embodiment of FIG. 15, six horizontal bars are coupled to each of two opposing sides of the frame, however more or fewer horizontal bars may be implemented. In the illustrated embodiment, each horizontal bar is coupled to a respective one of the vertical bars 1502.

The system 1500 may further include a mechanism 1506 for manipulating logs or other objects. The mechanism 1506 may be coupled (e.g., removably coupled) to the system 1500 and/or truck 200. The mechanism comprises a movable arm 1510 and a grapple 1508 coupled to an end of the movable arm 1510.

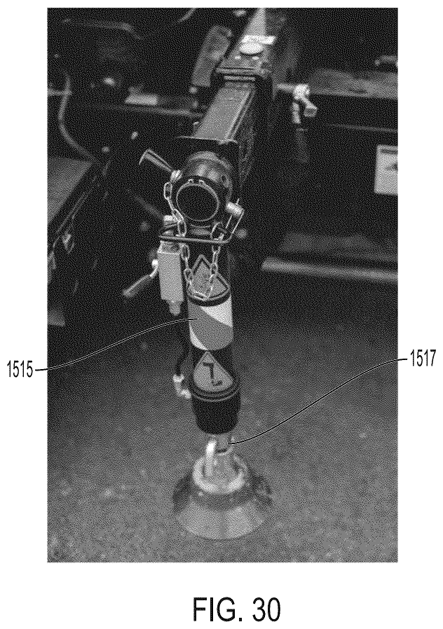

The system 1500 may further include one of more stabilizers 1515. The one or more stabilizers 1515 may facilitate stabilizing the truck 200 and system 1500 when the system 1500 is stationary (e.g., when the system 1500 is used for loading one or more logs 1520 onto the deck 102). In some embodiments, the system 1500 may include at least one stabilizer 1515 on each of two opposing sides of the system 1500. As shown in FIG. 30, the stabilizer 1515 may include a retractable portion 1517 which may be extended such that the stabilizer contacts the ground 1515 when in use, and retracted when not in use.

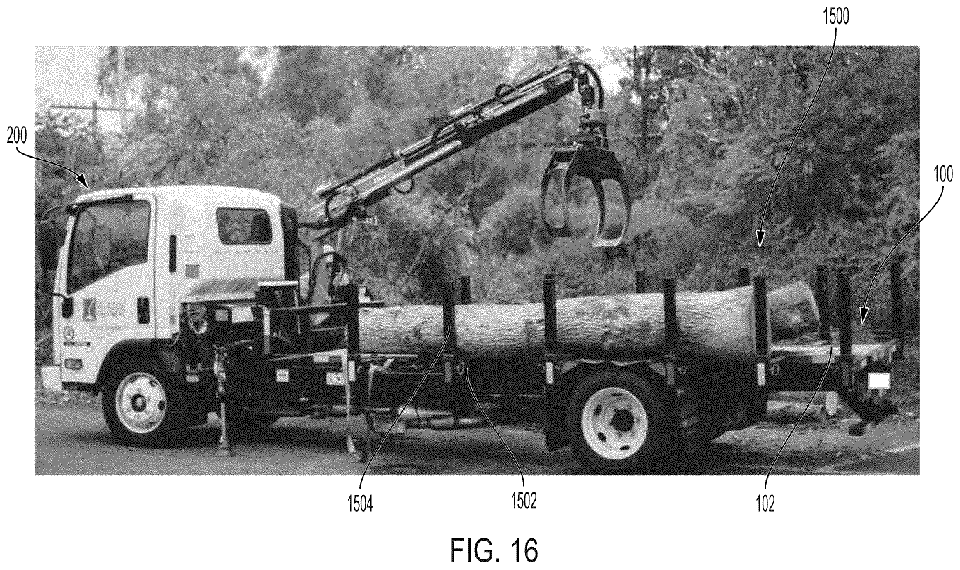

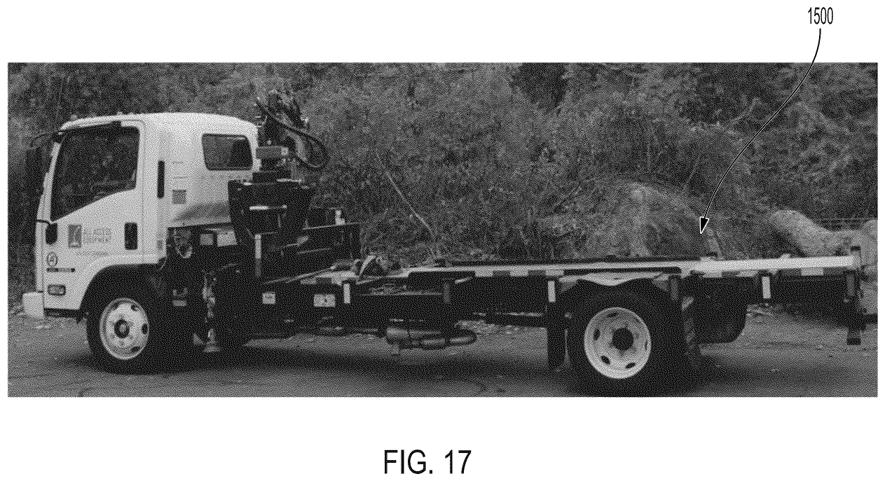

FIG. 16 illustrates an additional view of the system of FIG. 15, in accordance with some embodiments of the technology described herein. FIG. 17 illustrates aspects of the system for use as a log truck, in accordance with some embodiments of the technology described herein. In the illustrated embodiment of FIG. 17, the vertical bars 1504 are removed from the system 1500.

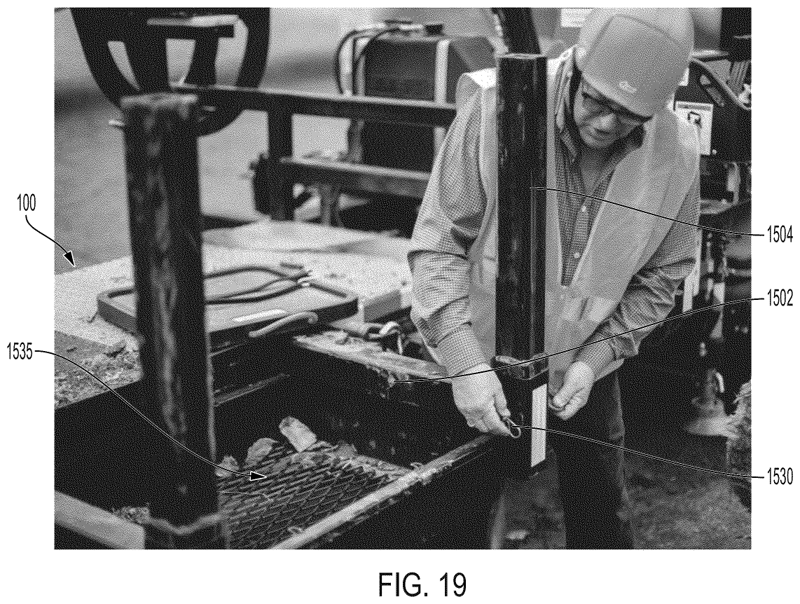

FIGS. 19-22 illustrates aspects of a frame of the system for use as a log truck, in accordance with some embodiments of the technology described herein. In particular, FIGS. 19-22 illustrate a process for decoupling the vertical bars 1504 from the frame 104. It may be advantageous to decouple the vertical bars 1504 from the frame 104 and store the vertical bars 1504 when an aerial lift is loaded onto and/or unloaded from the system 1500.

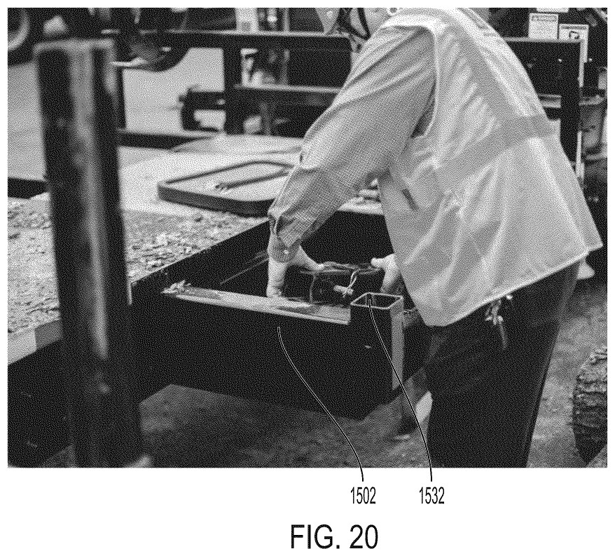

As shown in FIGS. 19-20, each vertical bar 1504 may be inserted into a respective opening 1532 (e.g., a pocket) in a respective horizontal bar 1502. A fastener 1530 may be used to secure respective ones of the vertical bars 1504 to the frame 104. In some embodiments, fastener 1530 may comprise a slide-in lock pin. To decouple a vertical bar 1504 from the frame 104, the fastener 1530 may be removed and the vertical bar 1504 may be removed from the opening 1532 in the horizontal bar 1502, as shown in FIGS. 19-20.

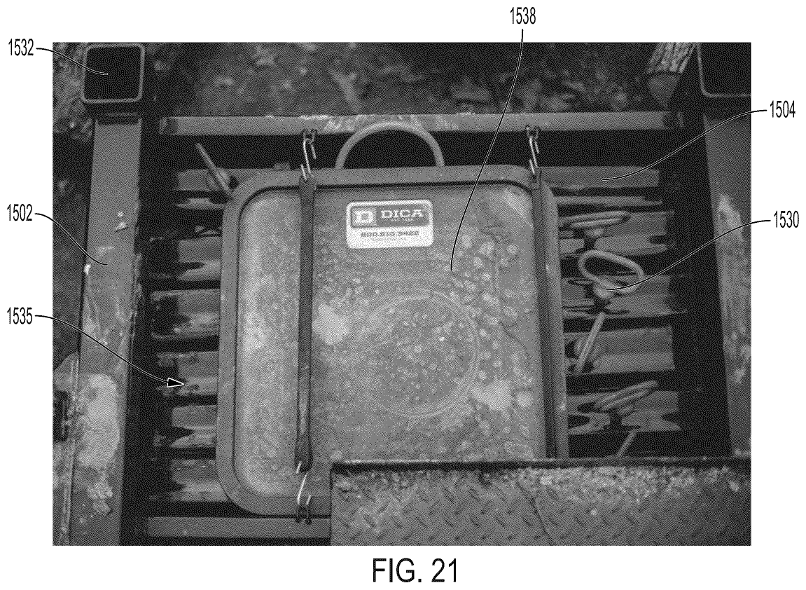

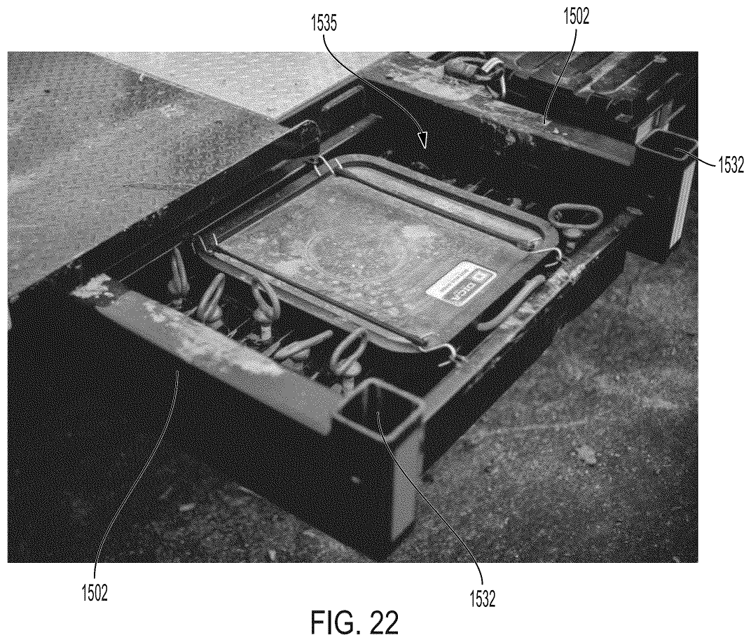

As shown in FIGS. 21-22, the vertical bars 1504 may be stored when not in use. In the illustrated embodiments, the system 1500 includes a tray 1535 disposed between adjacent horizontal bars 1502 for storing the vertical bars 1504 when not in use. In some embodiments, the system 1500 may include a tray 1535 on each of two opposing sides of the system 1500. A lid 1538 may secure the vertical bars 1504 within the tray 1535.

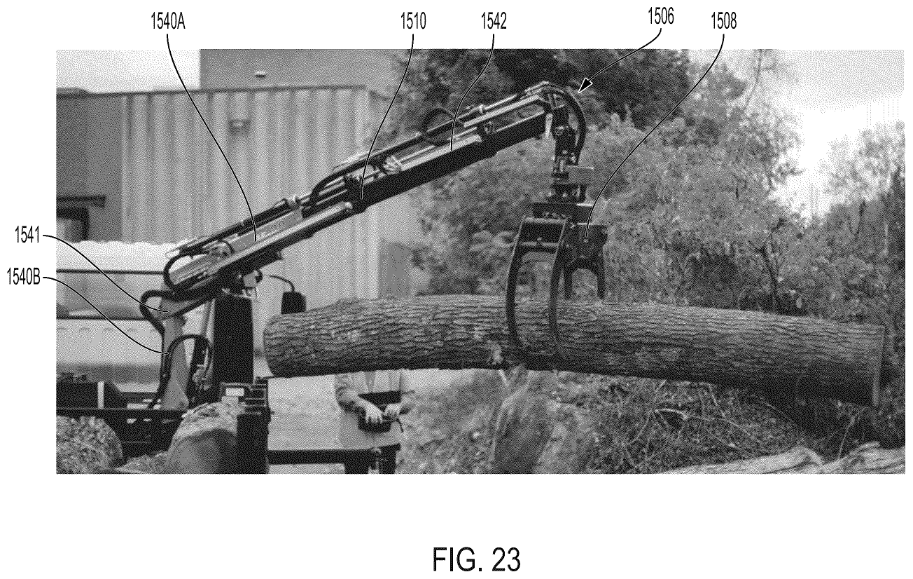

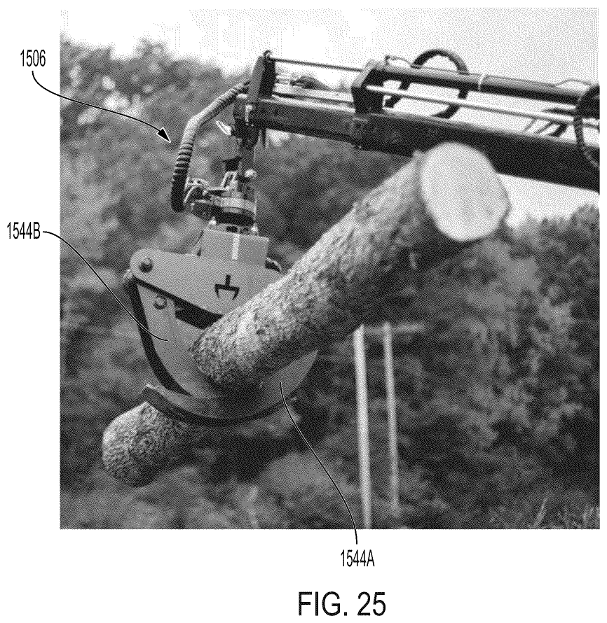

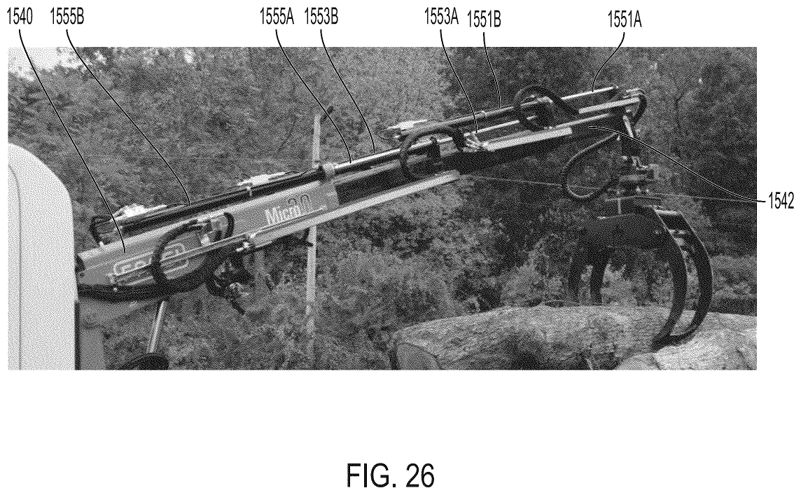

FIGS. 23-29 illustrate aspects of a movable grapple of the system for use as a log truck, in accordance with some embodiments of the technology described herein. FIG. 23 illustrates mechanism 1506 which may be used to move one or more logs (e.g., as shown in FIG. 23). As described herein, mechanism 1506 comprises a movable arm 1510 and a grapple 1508 disposed at an end of the movable arm 1510.

The movable arm 1510 comprises a fixed portion 1540 and a retractable portion 1542. The fixed portion 1540 may be fixed in that it may not be retractable in contrast to retractable portion 1542. The fixed portion 1540 may comprise first and second portions 1540A-B. Second fixed portion 1540B may comprise a base of the movable arm and may be coupled to the truck 200 and/or frame 104. The second fixed portion 1540B may pivot about a point at which the second fixed portion 1540B is coupled to the truck 200 and/or frame 104 providing a first degree of freedom for the movable arm 1510. The first fixed portion 1540A is coupled to second fixed portion 1540 at a point 1541 about which the first fixed portion 1540 may pivot, providing a second degree of freedom for the movable arm 1510.

Retractable portion 1542 of movable arm 1510 may comprise multiple telescoping portions 1551A, 1553A, and 1555A which, when retracted, may be received by respective receiving portions 1551B, 1553B, and 1555C. The ability to expand and retract one or more of the telescoping portions of retractable portion 1542 provides a third degree of freedom for movable arm 1510.

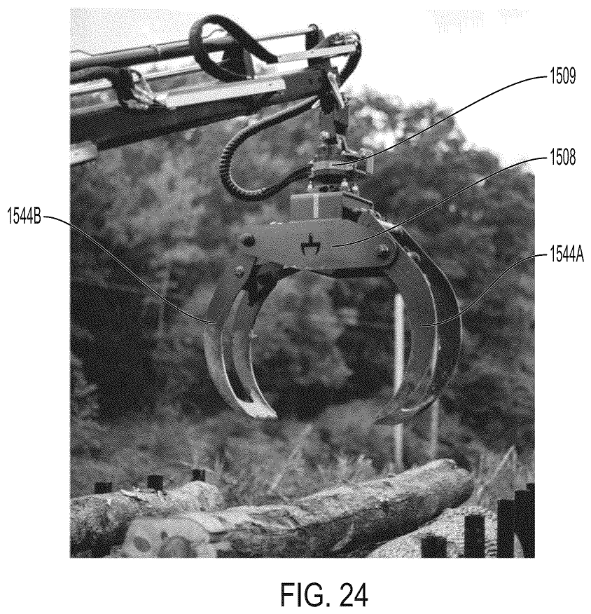

Mechanism 1506 further comprises grapple 1508. As described herein, grapple 1508 may be coupled to an end of the movable arm 1510. As shown in FIG. 23, grapple 1508 is coupled to an end of retractable portion 1542. The grapple 1508 may be configured to grasp one or more logs in order to pick up the one or more logs. As shown in FIG. 24, grapple 1508 comprises a pair of opposing jaws 1544A, 1544B which may be moved toward each other to grasp one or more logs and away from each other to release the one or more logs. A pivot point 1509 may be provided to provide an additional degree of freedom for grapple 1508. For example, the pivot point 1509 may allow the grapple 1508 to rotate along one or more axes (e.g., a yaw axis).

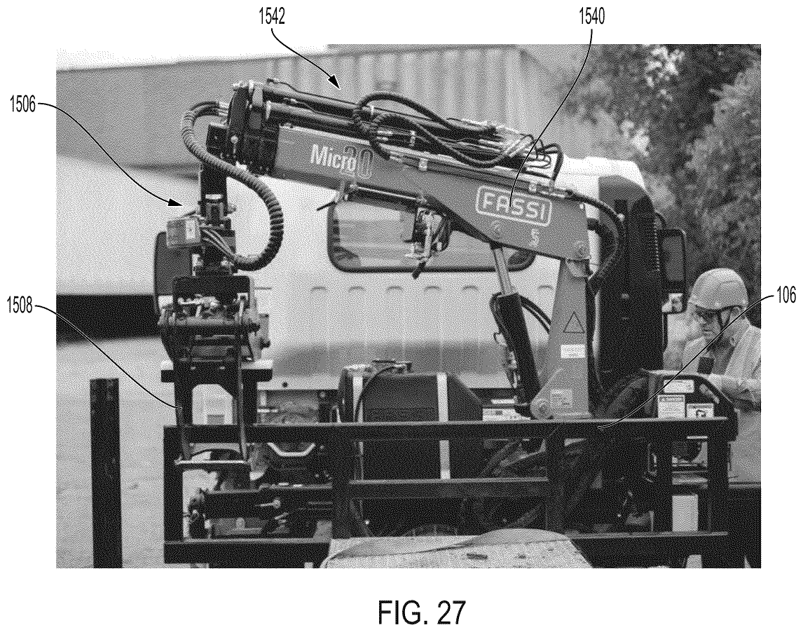

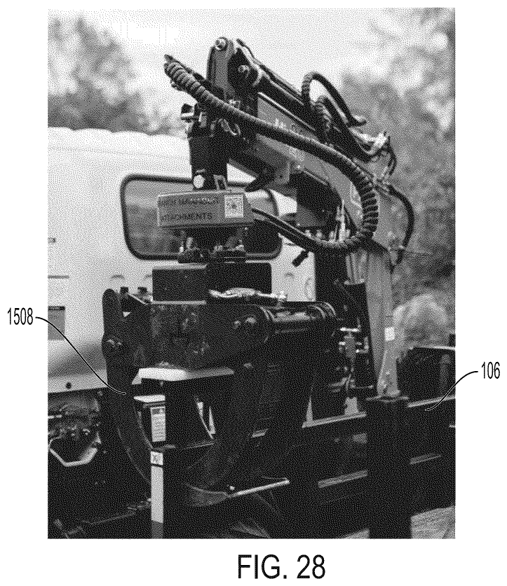

FIGS. 27-28 illustrate the mechanism 1506 in a storage position. For example, when the mechanism 1506 is not in use, it may be desirable to store the mechanism 1506 in a secure position. As shown in FIGS. 27-28, the retractable portion 1542, including the telescoping portions thereof, may be retracted, and the grapple may be secured (via jaws) around the headache rack 106 at the front end of the system 1500.

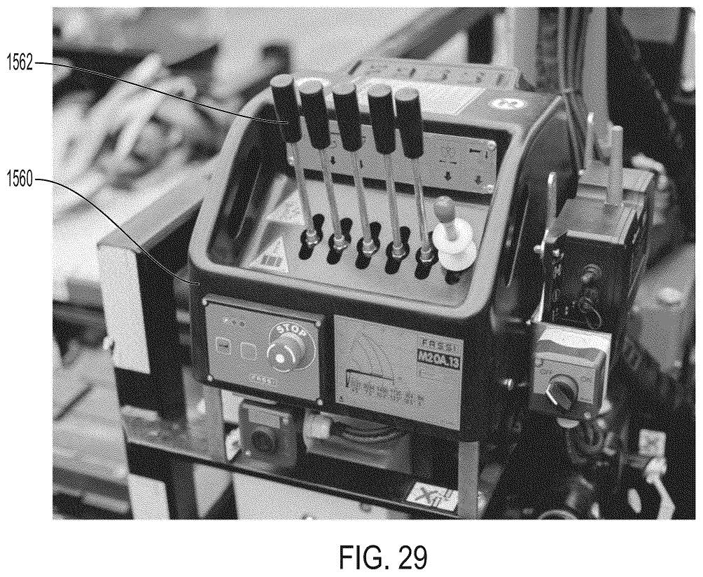

FIG. 29 illustrates a control 1560 for the mechanism 1506. The controller 1560 includes a plurality of controls 1562 for operating the mechanism 1506. For example, respective ones of the controls 1562 may be configured to control a respective degree of freedom of the mechanism 1506.

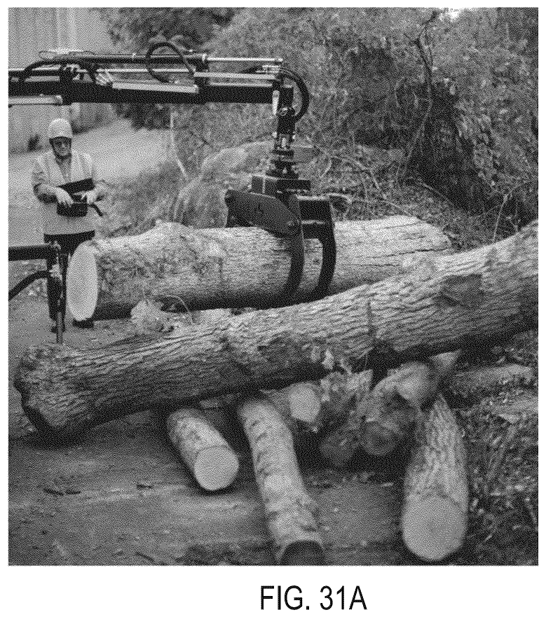

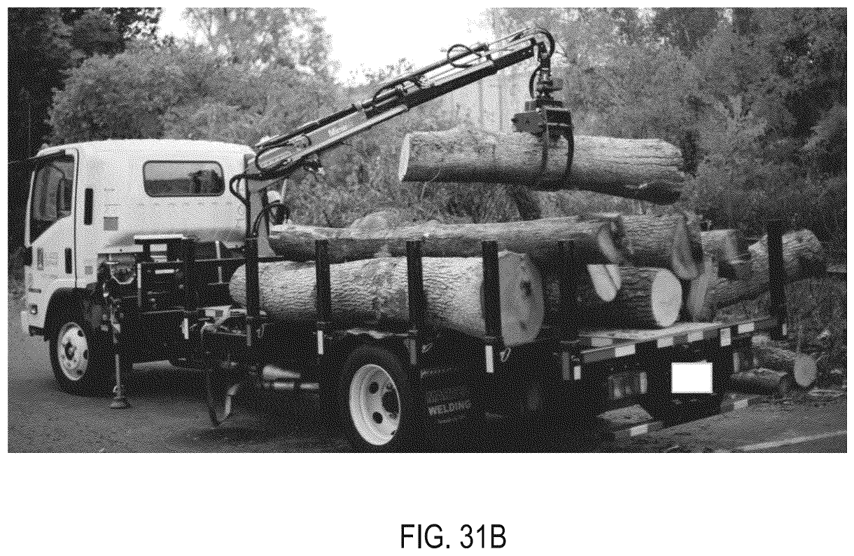

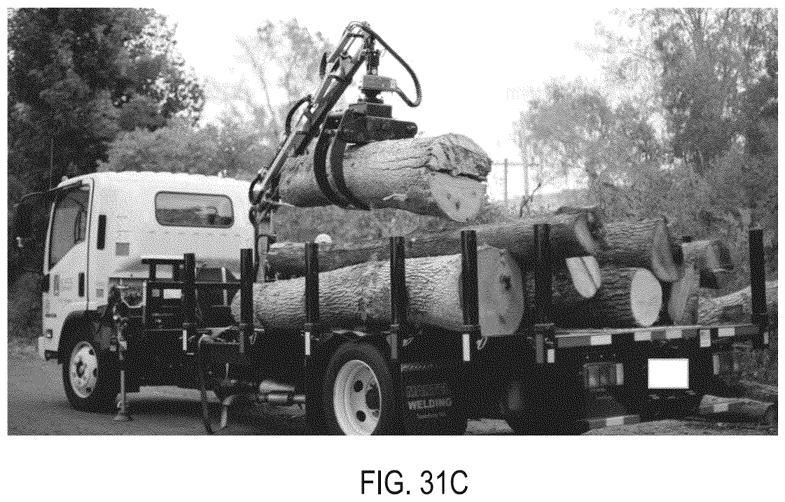

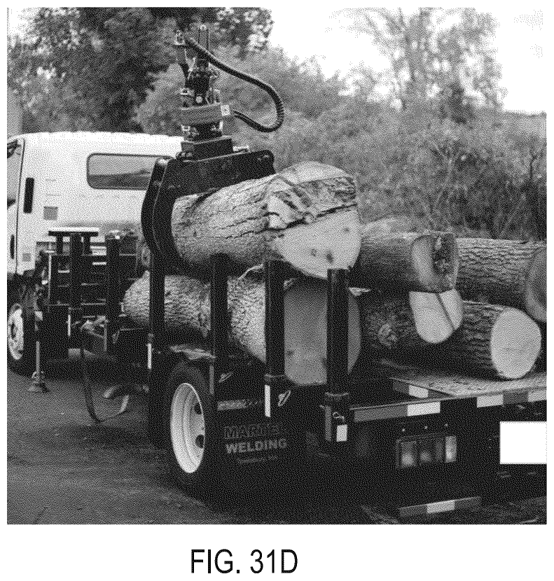

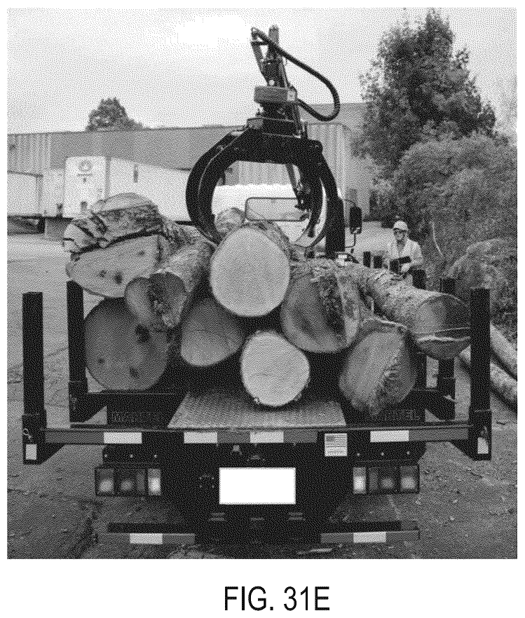

FIGS. 31A-31E illustrate use of a system to load a log onto a vehicle, in accordance with some embodiments of the technology described herein. FIG. 31A illustrates use of the grapple to pick up a log. FIGS. 31B-D illustrate use of the movable arm to move the log to the deck of the system 1500. FIG. 31E illustrates use of the grapple to release the log. An operator may remotely control the mechanism 1506 and components thereof during this process.

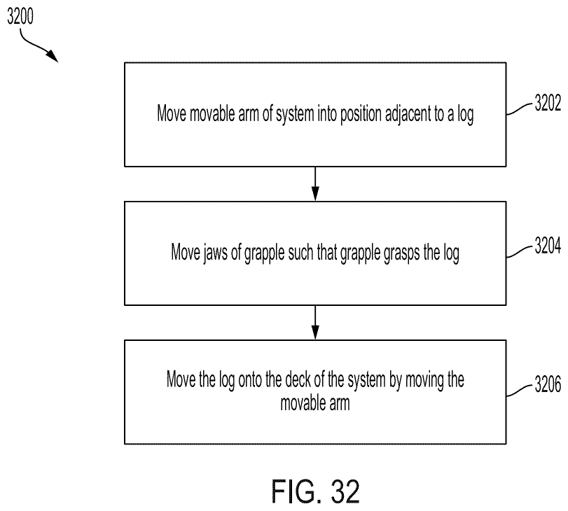

FIG. 32 illustrates an example method 3200 for loading one or more logs onto a system mounted on a chassis of a truck, in accordance with some embodiments of the technology described herein. The method 3200 may begin at act 3202 where a movable arm of the system (e.g., system 1500 described herein) is moved into a position adjacent to a log. At act 3204, jaws of a grapple of the system may be moved such that the grapple grasps the log (e.g., by moving the jaws towards each other). At act 3206, the log is moved onto a deck of the system by moving the movable arm. The method may further include releasing the log from the grapple by moving the jaws of the grapple away from each other.

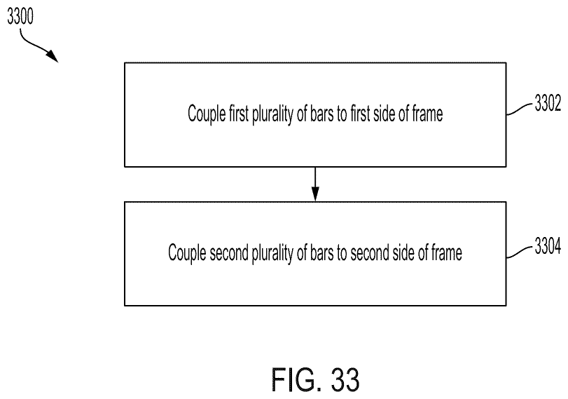

FIG. 33 illustrates an example method 3300 for converting a system for supporting an aerial lift into a system for transporting one or more logs, in accordance with some embodiments of the technology described herein. The method may begin at act 3302 where a first plurality of bars (e.g., vertical bars 1504 of system 1500) are coupled to a first side of a frame of the system. Respective ones of the first plurality of bars may extend in a direction substantially perpendicular to a length and a width of a deck of the system. At act 3304, a second plurality of bars (e.g., vertical bars 1504 of system 1500) may be coupled to a second side of the frame opposing the first side. Respective ones of the second plurality of bars may extend in the direction substantially perpendicular to the length and width of the deck.

In some embodiments, the method 3300 may further comprise extending the width of the frame of the system. Extending the width of the system may be performed by coupling a third plurality of bars (e.g., horizontal bars 1502) to the first side of the frame and coupling a fourth plurality of bars (e.g., horizontal bars 1502) to the second side of the frame. Respective ones of the third plurality of bars and respective ones of the fourth plurality of bars may extend in a direction along the width of the frame. Coupling the first plurality of bars to the frame at act 3302 may include coupling the first plurality of bars to the third plurality of bars (e.g., by inserting respective ones of the first plurality of bars into an opening in respective ones of the third plurality of bars) and coupling the second plurality of bars to the frame may include coupling the second plurality of bars to the fourth plurality of bars (e.g., by inserting respective ones of the second plurality of bars into an opening in respective ones of the fourth plurality of bars).

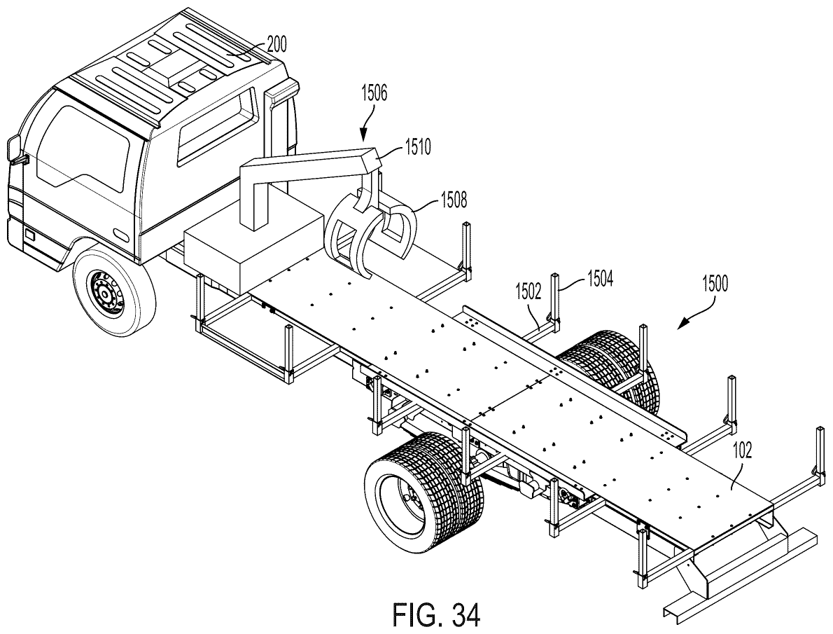

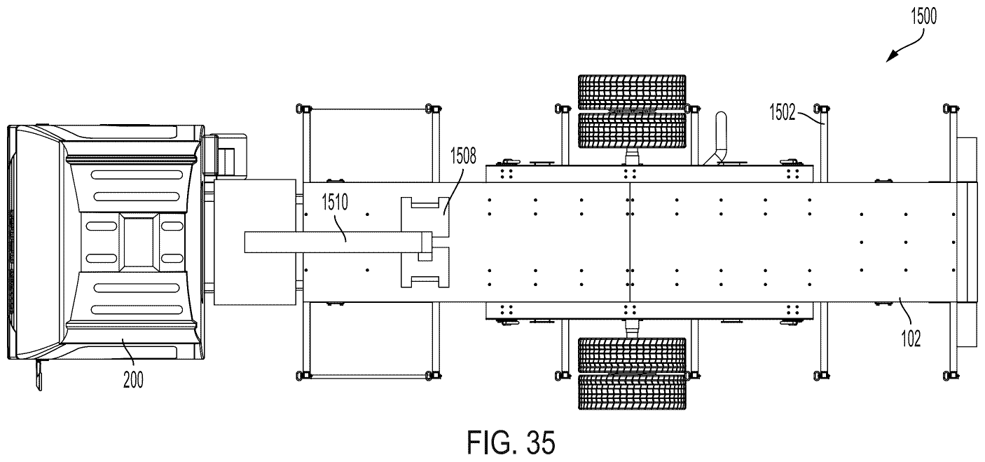

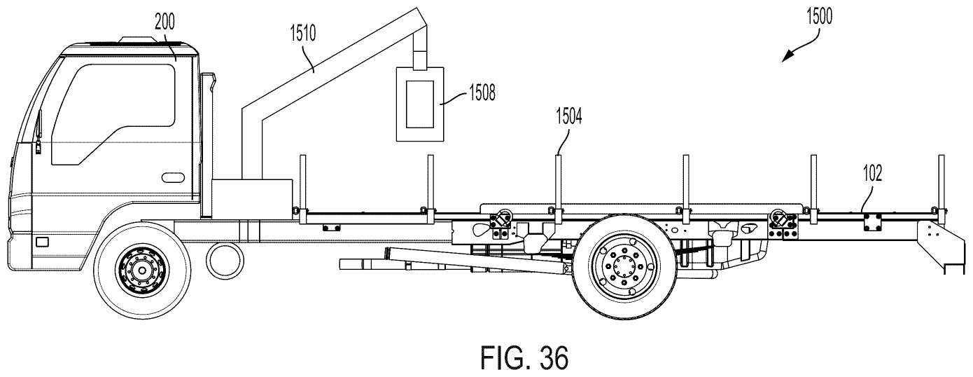

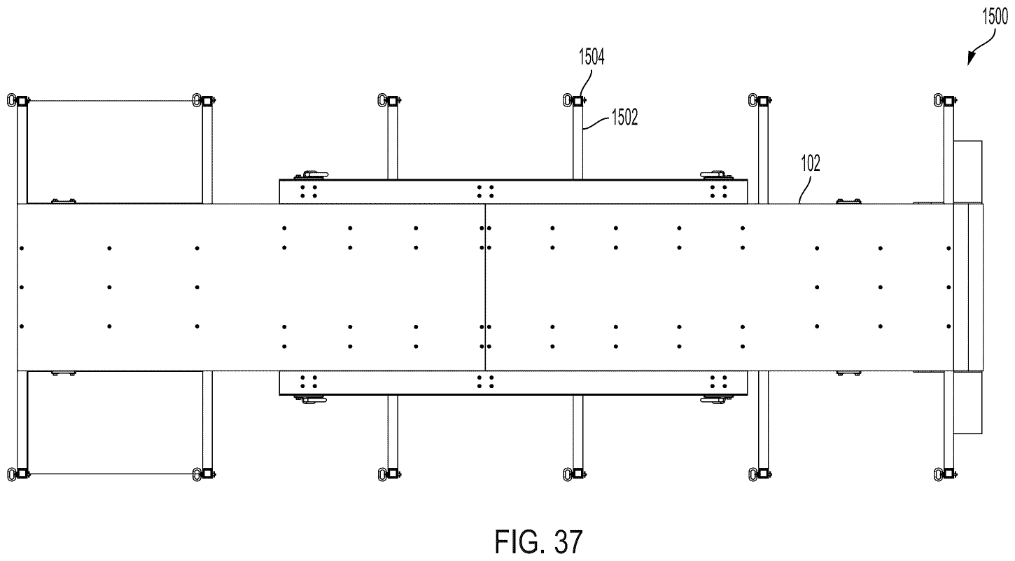

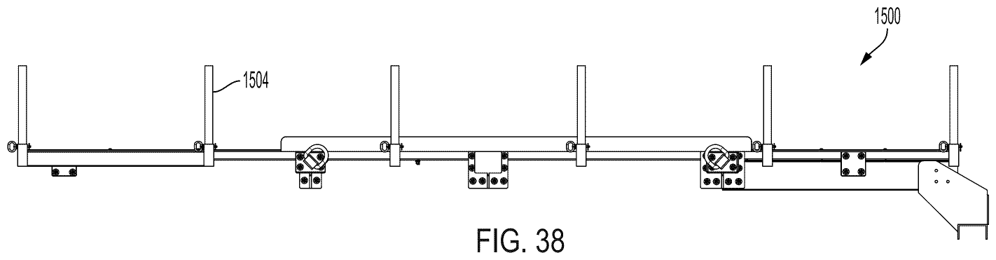

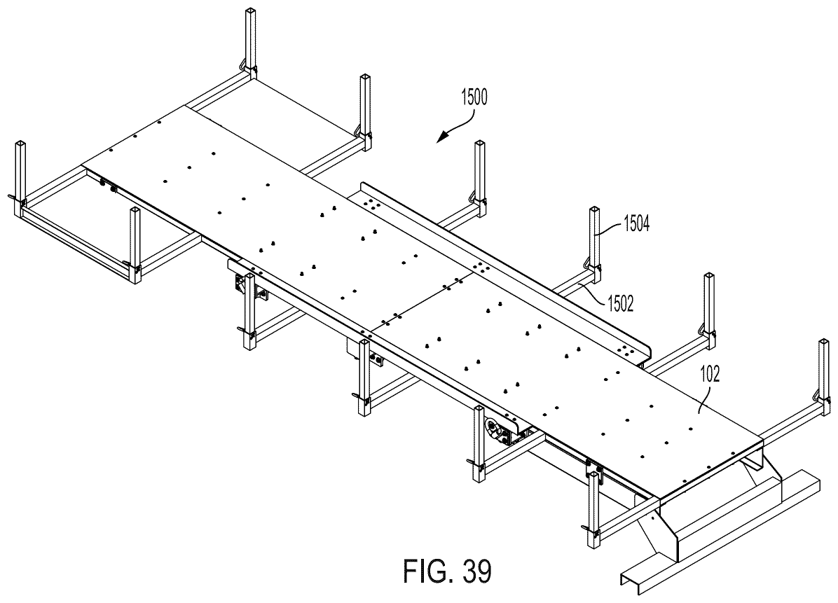

FIGS. 34-39 illustrate additional views of a system which may be used to adapt a vehicle into a log truck. FIG. 34 illustrates a perspective view of a system for use as a log truck mounted on a truck, in accordance with some embodiments of the technology described herein. FIG. 35 illustrates a top view of the system of FIG. 34 mounted on a truck, in accordance with some embodiments of the technology described herein. FIG. 36 illustrates a side view of the system of FIG. 34 mounted on a truck, in accordance with some embodiments of the technology described herein. FIG. 37 illustrates a top view of a system for use as a log truck, in accordance with some embodiments of the technology described herein. FIG. 38 illustrates a side view of the system of FIG. 37, in accordance with some embodiments of the technology described herein. FIG. 39 illustrates a perspective view of the system of FIG. 37, in accordance with some embodiments of the technology described herein.

The illustrated embodiments illustrate use of the system 1500 as a log truck, however, the system may be implemented to handle any materials that the movable arm and grapple described herein are capable of handling, such as steel beams, utility poles, or any other material that is desired to be handled by the movable arm and grapple.

As described herein, aspects of the system may be operated remotely. For example, an aerial lift may be remotely loaded and/or unloaded from/onto the system, as described herein. In some embodiments, the mechanism 1506 may be operated remotely. In some embodiments, remote operation may be performed by a user from the chassis of the truck to which the system is coupled.

Some aspects of the technology include techniques for installing the system onto a truck chassis. Aspects of installing the system onto a truck chassis are provided in Appendix A which forms a part of this disclosure. In some embodiments, the system may be built directly onto a truck chassis. In some embodiments, the system may be assembled and subsequently installed onto a truck chassis.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the technology described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The terms “approximately”, “substantially,” and “about” may be used to mean within ±20% of a target value in some embodiments, within ±10% of a target value in some embodiments, within ±5% of a target value in some embodiments, and within ±2% of a target value in some embodiments. The terms “approximately” and “about” may include the target value.

What is claimed is:

1. A system comprising:
a self-propelled aerial lift having a plurality of outriggers configured to support the aerial lift relative to a surface;
a kit configured to be installed on a chassis of a truck, the kit comprising:
a deck for supporting the self-propelled aerial lift; and
a frame configured to be coupled beneath the deck and mounted onto the chassis of the truck, wherein the system is configured to be removably coupled to the aerial lift, and wherein a width of the frame and a width of the deck are each less than a width between rear tires of the chassis such that the deck and the frame are disposed between the rear tires of the chassis when the kit is installed on the chassis of the truck.

2. The system of claim 1, wherein the width of the frame is 34 inches or less.

3. The system of claim 1, wherein the width of the deck is 34 inches or less.

4. The system of claim 1, wherein the deck is configured to:
support the self-propelled aerial lift during operation of the self-propelled aerial lift, wherein operating the self-propelled aerial lift comprises elevating a compartment of the self-propelled aerial lift configured to accommodate an operator;
permit the self-propelled aerial lift to remove itself from the deck; and
permit the self-propelled aerial lift to load itself onto the deck.

5. The system of claim 1, wherein the deck comprises first and second portions configured to be coupled together.

6. The system of claim 1, wherein the frame comprises first and second portions configured to be coupled together.

7. The system of claim 1, wherein the kit further comprises a headache bar configured to be coupled to a front end of the frame.

8. The system of claim 1, wherein the kit further comprises a rear bumper configured to be coupled to a rear end of the frame.

9. The system of claim 1, wherein the truck comprises a standard truck operable without a commercial driver's license.

10. The system of claim 1, wherein the kit further comprises a first and second plurality of bars coupled to respective opposing sides of the frame, wherein respective ones of the first and second plurality of bars extend in a direction substantially perpendicular to the width of the deck and a length of the deck.

11. The system of claim 10, wherein the kit further comprises a movable arm coupled to the truck, the movable arm comprising a grapple at an end of the movable arm.

12. The system of claim 11, wherein the grapple comprises a pair of opposing jaws.

13. The system of claim 11, wherein the movable arm comprises at least one telescoping portion.

14. The system of claim 11, wherein the movable arm comprises at least three degrees of freedom.

15. The system of claim 1, wherein the self-propelled aerial lift comprises a spider-style self-propelled aerial lift.

16. A method for use with a self-propelled aerial lift, the method comprising:
moving one or more outriggers of the self-propelled aerial lift from a folded configuration to a deployed configuration while the self-propelled aerial lift is supported by a deck of a system mounted on a chassis of a truck, wherein a distal end of each of the one or more outriggers at least partially supports the self-propelled aerial lift relative to a surface when the one or more outriggers are in the deployed configuration;
operating the self-propelled aerial lift while the self-propelled aerial lift is supported by the deck of the system and the one or more outriggers are in the deployed configuration, wherein operating the self-propelled aerial lift comprises elevating a compartment of the self-propelled aerial lift configured to accommodate an operator; and
unloading the self-propelled aerial lift from the deck of the system by remotely elevating the self-propelled aerial lift from the deck of the system such that the self-propelled aerial lift supports itself over the deck of the system and the deck can be removed from under the self-propelled aerial lift.

17. The method of claim 16, further comprising:
subsequent to unloading the self-propelled aerial lift from the deck of the system, remotely lowering the aerial lift onto the ground; and
moving the one or more outriggers of the aerial lift to the folded configuration.

18. The method of claim 17, further comprising moving the self-propelled aerial lift via a track coupled to the self-propelled aerial lift.

19. A method for use with a self-propelled aerial lift, the method comprising:
loading the self-propelled aerial lift onto a deck of a system coupled to a chassis of a truck, by:
remotely elevating the self-propelled aerial lift such that the chassis of the truck can be positioned beneath the self-propelled aerial lift; and
lowering the self-propelled aerial lift onto the deck of the system such that the self-propelled aerial lift is supported by the deck of the system; and
operating the self-propelled aerial lift while the self-propelled aerial lift is supported by the deck of the system and one or more outriggers are in a deployed configuration where a distal end of each of the one or more outriggers at least partially supports the self-propelled aerial lift relative to a surface, wherein operating the self-propelled aerial lift comprises elevating a compartment of the self-propelled aerial lift configured to accommodate an operator.

20. The method of claim 19, further comprising, subsequent to loading the self-propelled aerial lift onto the deck of the system:
moving the one or more outriggers of the self-propelled aerial lift from the deployed configuration to a folded configuration and
transporting the self-propelled aerial lift with the truck.
